(19) United States
(12) Patent Application Publication
(10) Pub. No.: US 2026/0074441 A1
(43) Pub. Date: Mar. 12, 2026

(54) Wireless Circuitry with Integrated Multi-Band Front End

(71) Applicant: Apple Inc., Cupertino, CA (US)

(72) Inventors: Qishan Yu, San Jose, CA (US); Bradley D Scoles, Morgan Hill, CA (US); Christopher J Huber, North Reading, MA (US)

(21) Appl. No.: 18/830,451

(22) Filed: Sep. 10, 2024

(51) Int. Cl. H01Q 21/28; H04B 1/04; H04B 1/40

(52) U.S. Cl. CPC H01Q 21/28; H04B 1/04; H04B 1/40; H04B 2001/0491

(57) ABSTRACT

An electronic device may include a transceiver, first and second phased antenna arrays, and a radio-frequency front end (RFFE) module coupled between the transceiver and the arrays. The first array may convey first radio-frequency (RF) signals in a Frequency Range 3 (FR3) band. The second array may convey second RF signals in a Frequency Range 2 (FR2) band. The transceiver may include signal chains for the first and second arrays. The signal chains for the first array may transmit and/or receive the first RF signals in the FR3 band. The signal chains for the second array may convert baseband signals into intermediate frequency (IF) signals. An integrated circuit mounted to the RFFE module may convert the IF signals into the second RF signals and vice versa. The RFFE module may include FR2/FR3 selection switches that are shared by the first RF signals and the IF signals.

### FIELD

This disclosure relates generally to electronic devices, including electronic devices with wireless communications circuitry.

### BACKGROUND

Electronic devices are often provided with wireless communications capabilities. An electronic device with wireless communications capabilities has wireless communications circuitry that includes transceiver circuitry, front end circuitry, and antennas.

It can be desirable for the wireless communications circuitry to be able to convey radio-frequency signals in a set of different frequency bands. However, if care is not taken, it can be difficult to provide transceiver and front end circuitry that supports each frequency band in the set with satisfactory levels of performance without consuming an excessive amount of space and/or power in the device.

### SUMMARY

An electronic device may include wireless circuitry for performing wireless communications. The wireless circuitry may include a transceiver chip, first and second phased antenna arrays, and a radio-frequency front end (RFFE) module communicatively coupled between the transceiver chip and the first and second phased antenna arrays. The first phased antenna array may convey first radio-frequency (RF) signals in a Frequency Range 3 (FR3) band using first and second orthogonal polarizations. The second phased antenna array may convey second RF signals in a Frequency Range 2 (FR2) band using the first and second orthogonal polarizations.

The transceiver chip may include signal chains for the first phased antenna array and signal chains for the second phased antenna array. The signal chains for the first phased antenna array may transmit and/or receive the first RF signals in the FR3 band. The signal chains for the second phased antenna array may convert baseband signals into intermediate frequency (IF) signals at frequencies close to the FR3 band. The IF signals may be conveyed between the transceiver chip and the RFFE module. An integrated circuit (IC) may be mounted to the RFFE module. The IC may convert the IF signals into the second RF signals and may convert the second RF signals into the IF signals. The RFFE module may include FR2/FR3 selection switches that are shared by both the first RF signals and the IF signals.

An aspect of the disclosure provides a radio-frequency front end (RFFE) module. The RFFE module can include a first switch on the substrate and having first, second, and third ports. The RFFE module can include a second switch on the substrate and having fourth and fifth ports. The RFFE module can include a transmit path on the substrate that couples the second port to the fourth port. The RFFE module can include an integrated circuit (IC) mounted to the substrate. The RFFE module can include an intermediate frequency (IF) path on the substrate that couples the third port to the IC. The second switch can be configured to communicatively couple the transmit path to a first phased antenna array via the fifth port. The IC can be configured to communicatively couple the IF path to a second phased antenna array. The first switch can be configured to route an IF signal between the first port and the IF path. The first switch can be configured to route a radio-frequency (RF) signal from the first port onto the transmit path.

An aspect of the disclosure provides a transceiver chip. The transceiver chip can include a first transmit chain that includes a first mixer configured to upconvert a first baseband signal to produce a first radio-frequency (RF) signal in a Frequency Range 3 (FR3) band. The transceiver chip can include a second transmit chain that includes a second mixer configured to upconvert a second baseband signal to produce a first intermediate frequency (IF) signal at a frequency close to the FR3 band, the second baseband signal including first wireless data to be transmitted in a Frequency Range 2 (FR2) band that is higher than the FR3 band. The transceiver chip can include a first receive chain that includes a third mixer configured to downconvert a second RF signal from the FR3 band to produce a third baseband signal. The transceiver chip can include a second receive chain that includes a fourth mixer configured to downconvert a second IF signal at the frequency close to the FR3 band to produce a fourth baseband signal. The transceiver chip can include a switch configured to communicatively couple one or more of the first transmit chain, the second transmit chain, the first receive chain, and the second receive chain to one or more ports of a RF front end (RFFE) module.

An aspect of the disclosure provides an electronic device. The electronic device can include a first phased antenna array configured to convey first radio-frequency (RF) signals in a Frequency Range 3 (FR3) band. The electronic device can include a second phased antenna array configured to convey second RF signals in a Frequency Range 2 (FR2) band. The electronic device can include a transceiver chip. The transceiver chip can include first signal chains configured to convert the first RF signals between the FR3 band and baseband. The transceiver chip can include second signal chains configured to convert intermediate frequency (IF) signals between baseband and a frequency close to the FR3 band. The electronic device can include a radio-frequency front end (RFFE) module communicatively coupled between the transceiver chip and the first and second phased antenna arrays. The electronic device can include an integrated circuit (IC) mounted to the RFFE module, the IC being configured to convert the second RF signals into the IF signals and being configured to convert the IF signals into the second RF signals.

### BRIEF DESCRIPTION OF THE DRAWINGS

FIG. 1 is a perspective view of an illustrative electronic device in accordance with some embodiments.

FIG. 2 is a schematic diagram of illustrative circuitry in an electronic device in accordance with some embodiments.

FIG. 3 is a diagram of an illustrative phased antenna array in accordance with some embodiments.

FIG. 4 is a perspective view of an illustrative dual-polarized antenna in accordance with some embodiments.

FIG. 5 is a top view of illustrative wireless circuitry that includes first and second phased antenna arrays that convey radio-frequency signals in different frequency bands in accordance with some embodiments

FIG. 6 is a top view of illustrative wireless circuitry including first and second phased antenna arrays that are interleaved with each other in accordance with some embodiments.

FIG. 7 is a top view of illustrative wireless circuitry including overlapping first and second phased antenna arrays in accordance with some embodiments.

FIG. 8 is a circuit diagram of illustrative wireless circuitry including a single transceiver that is used to perform both Frequency Range 2 (FR2) and Frequency Range 3 (FR3) communications via an integrated FR2/FR3 radio-frequency head in accordance with some embodiments.

FIG. 9 is a circuit diagram of an illustrative integrated FR2/FR3 radio-frequency head in accordance with some embodiments.

### DETAILED DESCRIPTION

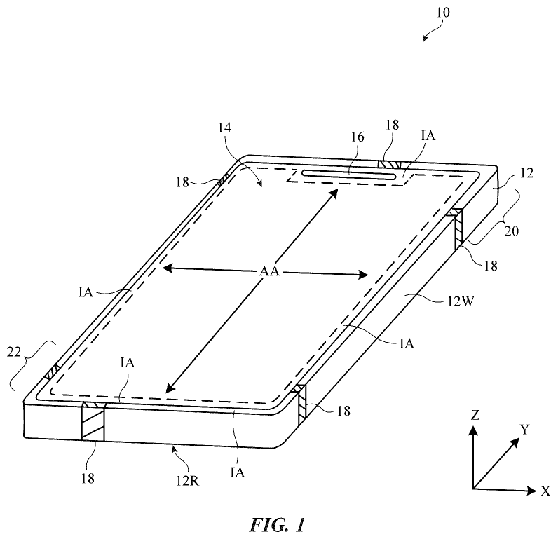

An electronic device such as electronic device 10 of FIG. 1 may be provided with wireless circuitry that includes antennas. The antennas may be used to transmit and/or receive wireless radio-frequency signals.

Device 10 may be, for example, a laptop computer, a desktop computer, a computer monitor containing an embedded computer, a tablet computer, a cellular telephone, a media player, or another handheld or portable electronic device, a smaller device such as a wristwatch device, a pendant device, an accessory device such as wireless headphones, a wireless earbud/earpiece, gaming controller, or user input device (e.g., a mouse, keyboard, pointing device, etc.), a head-mounted device such as goggles, eyeglasses, a helmet, or other equipment worn on a user's head (e.g., an augmented, virtual, or mixed reality head-mounted display device), or another wearable or miniature device, a television, a computer display device that does or does not contain an embedded computer, a gaming device (e.g., a video gaming console), a video streaming or playback device, a video transmitting device, a camera, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, equipment that implements the functionality of two or more of these devices, or other electronic equipment. The example of FIG. 1 in which device 10 has a rectangular form factor is illustrative and non-limiting.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials. In some situations, parts of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may, if desired, have a display such as display 14. Display 14 may be mounted on the front face of device 10. Display 14 may be a touch screen that incorporates capacitive touch electrodes or may be insensitive to touch. The rear face of housing 12 (i.e., the face of device 10 opposing the front face of device 10) may have a substantially planar housing wall such as rear housing wall 12R (e.g., a planar housing wall). Rear housing wall 12R may have slots that pass entirely through the rear housing wall and that therefore separate portions of housing 12 from each other. Rear housing wall 12R may include conductive portions and/or dielectric portions. If desired, rear housing wall 12R may include a planar metal layer covered by a thin layer or coating of dielectric such as glass, plastic, sapphire, or ceramic (e.g., a dielectric cover layer). Housing 12 may also have shallow grooves that do not pass entirely through housing 12. The slots and grooves may be filled with plastic or other dielectric materials. If desired, portions of housing 12 that have been separated from each other (e.g., by a through slot) may be joined by internal conductive structures (e.g., sheet metal or other metal members that bridge the slot).

Housing 12 may include peripheral housing structures such as peripheral structures 12W. Conductive portions of peripheral structures 12W and conductive portions of rear housing wall 12R may sometimes be referred to herein collectively as conductive structures of housing 12. Peripheral structures 12W may run around the periphery of device 10 and display 14. In configurations in which device 10 and display 14 have a rectangular shape with four edges, peripheral structures 12W may be implemented using peripheral housing structures that have a rectangular ring shape with four corresponding edges and that extend from rear housing wall 12R to the front face of device 10 (as an example). In other words, device 10 may have a length (e.g., measured parallel to the Y-axis), a width that is less than the length (e.g., measured parallel to the X-axis), and a height (e.g., measured parallel to the Z-axis) that is less than the width. Peripheral structures 12W or part of peripheral structures 12W may serve as a bezel for display 14 (e.g., a cosmetic trim that surrounds all four sides of display 14 and/or that helps hold display 14 to device 10) if desired. Peripheral structures 12W may, if desired, form sidewall structures for device 10 (e.g., by forming a metal band with vertical sidewalls, curved sidewalls, etc.).

Peripheral structures 12W may be formed from a conductive material such as metal and may therefore sometimes be referred to as peripheral conductive housing structures, conductive housing structures, peripheral metal structures, peripheral conductive sidewalls, peripheral conductive sidewall structures, conductive housing sidewalls, peripheral conductive housing sidewalls, sidewalls, sidewall structures, or a peripheral conductive housing member (as examples). Peripheral conductive housing structures 12W may be formed from a metal such as stainless steel, aluminum, alloys, or other suitable materials. One, two, or more than two separate structures may be used in forming peripheral conductive housing structures 12W.

It is not necessary for peripheral conductive housing structures 12W to have a uniform cross-section. For example, the top portion of peripheral conductive housing structures 12W may, if desired, have an inwardly protruding ledge that helps hold display 14 in place. The bottom portion of peripheral conductive housing structures 12W may also have an enlarged lip (e.g., in the plane of the rear surface of device 10). Peripheral conductive housing structures 12W may have substantially straight vertical sidewalls, may have sidewalls that are curved, or may have other suitable shapes. In some configurations (e.g., when peripheral conductive housing structures 12W serve as a bezel for display 14), peripheral conductive housing structures 12W may run around the lip of housing 12 (i.e., peripheral conductive housing structures 12W may cover only the edge of housing 12 that surrounds display 14 and not the rest of the sidewalls of housing 12).

Rear housing wall 12R may lie in a plane that is parallel to display 14. In configurations for device 10 in which some or all of rear housing wall 12R is formed from metal, it may be desirable to form parts of peripheral conductive housing structures 12W as integral portions of the housing structures forming rear housing wall 12R. For example, rear housing wall 12R of device 10 may include a planar metal structure and portions of peripheral conductive housing structures 12W on the sides of housing 12 may be formed as flat or curved vertically extending integral metal portions of the planar metal structure (e.g., housing structures 12R and 12W may be formed from a continuous piece of metal in a unibody configuration). Housing structures such as these may, if desired, be machined from a block of metal and/or may include multiple metal pieces that are assembled together to form housing 12. Rear housing wall 12R may have one or more, two or more, or three or more portions. Peripheral conductive housing structures 12W and/or conductive portions of rear housing wall 12R may form one or more exterior surfaces of device 10 (e.g., surfaces that are visible to a user of device 10) and/or may be implemented using internal structures that do not form exterior surfaces of device 10 (e.g., conductive housing structures that are not visible to a user of device 10 such as conductive structures that are covered with layers such as thin cosmetic layers, protective coatings, and/or other coating/cover layers that may include dielectric materials such as glass, ceramic, plastic, or other structures that form the exterior surfaces of device 10 and/or serve to hide peripheral conductive housing structures 12W and/or conductive portions of rear housing wall 12R from view of the user).

Display 14 may have an array of pixels that form an active area AA that displays images for a user of device 10. For example, active area AA may include an array of display pixels. The array of pixels may be formed from liquid crystal display (LCD) components, an array of electrophoretic pixels, an array of plasma display pixels, an array of organic light-emitting diode display pixels or other light-emitting diode pixels, an array of electrowetting display pixels, or display pixels based on other display technologies. If desired, active area AA may include touch sensors such as touch sensor capacitive electrodes, force sensors, or other sensors for gathering a user input.

Display 14 may have an inactive border region that runs along one or more of the edges of active area AA. Inactive area IA of display 14 may be free of pixels for displaying images and may overlap circuitry and other internal device structures in housing 12. To block these structures from view by a user of device 10, the underside of the display cover layer or other layers in display 14 that overlap inactive area IA may be coated with an opaque masking layer in inactive area IA. The opaque masking layer may have any suitable color. Inactive area IA may include a recessed region such as notch 24 that extends into active area AA. Active area AA may, for example, be defined by the lateral area of a display module for display 14 (e.g., a display module that includes pixel circuitry, touch sensor circuitry, etc.). The display module may have a recess or notch in upper region 20 of device 10 that is free from active display circuitry (i.e., that forms notch 24 of inactive area IA). Notch 24 may be a substantially rectangular region that is surrounded (defined) on three sides by active area AA and on a fourth side by peripheral conductive housing structures 12W. Alternatively, notch 24 may be implemented as an inactive island of display 14 that is surrounded on all sides by active area AA. One or more sensors may be aligned with notch 24 and may transmit and/or receive light through display 14 within notch 24.

Display 14 may be protected using a display cover layer such as a layer of transparent glass, clear plastic, transparent ceramic, sapphire, or other transparent crystalline material, or other transparent layer(s). The display cover layer may have a planar shape, a convex curved profile, a shape with planar and curved portions, a layout that includes a planar main area surrounded on one or more edges with a portion that is bent out of the plane of the planar main area, or other suitable shapes. The display cover layer may cover the entire front face of device 10. In another suitable arrangement, the display cover layer may cover substantially all of the front face of device 10 or only a portion of the front face of device 10. Openings may be formed in the display cover layer. For example, an opening may be formed in the display cover layer to accommodate a button. An opening may also be formed in the display cover layer to accommodate ports such as speaker port 16 in notch 24 or a microphone port. Openings may be formed in housing 12 to form communications ports (e.g., an audio jack port, a digital data port, etc.) and/or audio ports for audio components such as a speaker and/or a microphone if desired.

Display 14 may include conductive structures such as an array of capacitive electrodes for a touch sensor, conductive lines for addressing pixels, driver circuits, etc. Housing 12 may include internal conductive structures such as metal frame members and a planar conductive housing member (sometimes referred to as a conductive support plate or backplate) that spans the walls of housing 12 (e.g., a substantially rectangular sheet formed from one or more metal parts that is welded or otherwise connected between opposing sides of peripheral conductive housing structures 12W). The conductive support plate may form an exterior rear surface of device 10 or may be covered by a dielectric cover layer such as a thin cosmetic layer, protective coating, and/or other coatings that may include dielectric materials such as glass, ceramic, plastic, or other structures that form the exterior surfaces of device 10 and/or serve to hide the conductive support plate from view of the user (e.g., the conductive support plate may form part of rear housing wall 12R). Device 10 may also include conductive structures such as printed circuit boards, components mounted on printed circuit boards, and other internal conductive structures. These conductive structures, which may be used in forming a ground plane in device 10, may extend under active area AA of display 14, for example.

In regions 22 and 20, openings may be formed within the conductive structures of device 10 (e.g., between peripheral conductive housing structures 12W and opposing conductive ground structures such as conductive portions of rear housing wall 12R, conductive traces on a printed circuit board, conductive electrical components in display 14, etc.). These openings, which may sometimes be referred to as gaps, may be filled with air, plastic, and/or other dielectrics and may be used in forming slot antenna resonating elements for one or more antennas in device 10, if desired.

Conductive housing structures and other conductive structures in device 10 may serve as a ground plane for the antennas in device 10. The openings in regions 22 and 20 may serve as slots in open or closed slot antennas, may serve as a central dielectric region that is surrounded by a conductive path of materials in a loop antenna, may serve as a space that separates an antenna resonating element such as a strip antenna resonating element or an inverted-F antenna resonating element from the ground plane, may contribute to the performance of a parasitic antenna resonating element, or may otherwise serve as part of antenna structures formed in regions 22 and 20. If desired, the ground plane that is under active area AA of display 14 and/or other metal structures in device 10 may have portions that extend into parts of the ends of device 10 (e.g., the ground may extend towards the dielectric-filled openings in regions 22 and 20), thereby narrowing the slots in regions 22 and 20. Region 22 may sometimes be referred to herein as lower region 22 or lower end 22 of device 10. Region 20 may sometimes be referred to herein as upper region 20 or upper end 20 of device 10.

In general, device 10 may include any suitable number of antennas (e.g., one or more, two or more, three or more, four or more, etc.). The antennas in device 10 may be located at opposing first and second ends of an elongated device housing (e.g., at lower region 22 and/or upper region 20 of device 10 of FIG. 1), along one or more edges of a device housing, in the center of a device housing, in other suitable locations, or in one or more of these locations. The arrangement of FIG. 1 is illustrative and non-limiting.

Portions of peripheral conductive housing structures 12W may be provided with peripheral gap structures. For example, peripheral conductive housing structures 12W may be provided with one or more dielectric-filled gaps such as gaps 18, as shown in FIG. 1. The gaps in peripheral conductive housing structures 12W may be filled with dielectric such as polymer, ceramic, glass, air, other dielectric materials, or combinations of these materials. Gaps 18 may divide peripheral conductive housing structures 12W into one or more peripheral conductive segments. The conductive segments that are formed in this way may form parts of antennas in device 10 if desired. Other dielectric openings may be formed in peripheral conductive housing structures 12W (e.g., dielectric openings other than gaps 18) and may serve as dielectric antenna windows for antennas mounted within the interior of device 10. Antennas within device 10 may be aligned with the dielectric antenna windows for conveying radio-frequency signals through peripheral conductive housing structures 12W. Antennas within device 10 may also be aligned with inactive area IA of display 14 for conveying radio-frequency signals through display 14.

To provide an end user of device 10 with as large of a display as possible (e.g., to maximize an area of the device used for displaying media, running applications, etc.), it may be desirable to increase the amount of area at the front face of device 10 that is covered by active area AA of display 14. Increasing the size of active area AA may reduce the size of inactive area IA within device 10. This may reduce the area behind display 14 that is available for antennas within device 10. For example, active area AA of display 14 may include conductive structures that serve to block radio-frequency signals handled by antennas mounted behind active area AA from radiating through the front face of device 10. It would therefore be desirable to be able to provide antennas that occupy a small amount of space within device 10 (e.g., to allow for as large of a display active area AA as possible) while still allowing the antennas to communicate with wireless equipment external to device 10 with satisfactory efficiency bandwidth.

In a typical scenario, device 10 may have one or more upper antennas and one or more lower antennas. An upper antenna may, for example, be formed in upper region 20 of device 10. A lower antenna may, for example, be formed in lower region 22 of device 10. Additional antennas may be formed along the edges of housing 12 extending between regions 20 and 22 if desired. The antennas may be used separately to cover identical communications bands, overlapping communications bands, or separate communications bands. The antennas may be used to implement an antenna diversity scheme or a multiple-input-multiple-output (MIMO) antenna scheme. Other antennas for covering any other desired frequencies may also be mounted at any desired locations within the interior of device 10.

In implementations that are described herein as an example, device 10 may include multiple antennas arranged into at least first and second phased antenna arrays. The first and second phased antenna arrays may convey radio-frequency signals in different frequency bands through an inactive portion of display 14 (e.g., through the front face of device 10), a dielectric portion of rear housing wall 12R (e.g., through the rear face of device 10), and/or dielectric windows in peripheral conductive housing structures (e.g., through a sidewall of device 10). The example of FIG. 1 is illustrative and non-limiting. If desired, housing 12 may have other shapes (e.g., a square shape, cylindrical shape, spherical shape, combinations of these and/or different shapes, etc.). Housing 12 need not have peripheral conductive housing structures 12W. Device 10 need not have a display.

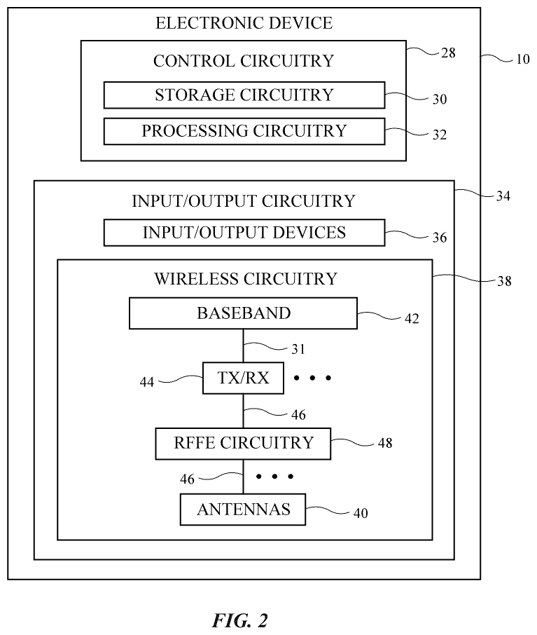

A schematic diagram of illustrative components that may be used in device 10 is shown in FIG. 2. As shown in FIG. 2, device 10 may include control circuitry 28. Control circuitry 28 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 30 may include storage that is integrated within device 10 and/or removable storage media.

Control circuitry 28 may include processing circuitry such as processing circuitry 32. Processing circuitry 32 may be used to control the operation of device 10. Processing circuitry 32 may include on one or more processors such as microprocessors, microcontrollers, digital signal processors, host processors, baseband processor integrated circuits, application specific integrated circuits, central processing units (CPUs), graphics processing units (GPUs), etc. Control circuitry 28 may be configured to perform operations in device 10 using hardware (e.g., dedicated hardware or circuitry), firmware, and/or software. Software code for performing operations in device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 28 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 28 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband (UWB) protocols), cellular telephone protocols (e.g., 3GPP 3G protocols, 4G (LTE) protocols, Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol (e.g., a WLAN RAT, a WPAN RAT, a cellular telephone RAT such as a 4G RAT, 5G RAT, 3G RAT, 6G RAT, etc., a UWB RAT, etc.).

Device 10 may include input-output circuitry 34. Input-output circuitry 34 may include input-output devices 36. Input-output devices 36 may be used to allow data to be supplied to device 10 and to allow data to be provided from device 10 to external devices. Input-output devices 36 may include user interface devices, data port devices, and other input-output components. For example, input-output devices 36 may include touch sensors, displays, light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, and joysticks, and other input-output devices may be coupled to device 10 using wired or wireless connections (e.g., some of input-output devices 36 may be peripherals that are coupled to a main processing unit or other portion of device 10 via a wired or wireless link).

Input-output circuitry 34 may include wireless circuitry 38 to support wireless communications. Wireless circuitry 38 (sometimes referred to herein as wireless communications circuitry 38) may include baseband circuitry such as baseband circuitry 42 (e.g., one or more baseband processors and/or other circuitry that operates at baseband), radio-frequency (RF) transceiver circuitry such as one or more transceivers (TX/RX) 44, radio-frequency front end (RFFE) circuitry such as RFFE circuitry 48, and one or more antennas 40. If desired, wireless circuitry 38 may include multiple antennas 40 that are arranged into a phased antenna array (sometimes referred to as a phased array antenna) that conveys radio-frequency signals within a corresponding signal beam that can be steered in different directions.

Baseband circuitry 42 may be coupled to transceiver(s) 44 over one or more baseband signal paths 31. Baseband circuitry 42 may include, for example, modulators (encoders) and demodulators (decoders) that operate on baseband signals. Transceiver(s) 44 may sometimes also be referred to herein as radio(s) 44. Each transceiver 44 may be coupled to one or more antennas 40 over one or more radio-frequency transmission line paths 46 (sometimes referred to herein as radio-frequency signal paths 46). RFFE circuitry 48 may be disposed on one or more radio-frequency transmission line paths 46 between one or more transceivers 44 and one or more antennas 40.

Each transceiver 44 may include a transmitter and/or receiver that transmits and/or receives radio-frequency signals. Each transceiver 44 may convey radio-frequency signals using one or more corresponding RATs. If desired, different transceivers 44 may convey radio-frequency signals using different RATs (e.g., a first transceiver 44 may convey cellular telephone signals, a second transceiver 44 may convey Wi-Fi signals, etc.). If desired, the same transceiver 44 may convey radio-frequency signals using two or more RATs (e.g., a given transceiver 44 may convey both Wi-Fi and Bluetooth signals, a given transceiver 44 may convey both 5G cellular telephone signals and 6G cellular telephone signals, a given transceiver 44 may both convey cellular telephone signals and receive satellite navigation signals, etc.).

Each transceiver 44 may be coupled to the same antenna 40 over different radio-frequency transmission line paths 46, two or more transceivers 44 may be coupled to the same antenna 40 over the same radio-frequency transmission line path, a given transceiver 44 may be coupled to different antennas over different radio-frequency transmission line paths, etc. In general, any desired number of one or more radio-frequency transmission line paths 46 may be used to couple one or more transceivers 44 to one or more antennas 40 and, if desired, two or more transceivers 44 may be coupled to the same antenna(s) 40 over the same radio-frequency transmission line path(s) 46. Any desired number of two or more of the transceivers 44 in wireless circuitry 38 may be coupled to the same RFFE circuitry 48 (e.g., RFFE circuitry 48 disposed on the one or more radio-frequency transmission line paths 46 coupling the two or more transceivers 44 to one or more antennas 40) or different respective transceivers 44 may be coupled to different respective RFFE circuitry 48. In general, wireless circuitry 38 may include any desired number of transceivers 44, any desired number of radio-frequency transmission line paths 46, and any desired number of antennas 40.

Radio-frequency transmission line path(s) 46 may be coupled to antenna feeds on one or more antennas 40. Each antenna feed may, for example, include a positive antenna feed terminal and a ground antenna feed terminal. Each radio-frequency transmission line path 46 may have a positive transmission line signal path that is coupled to one or more positive antenna feed terminals and may have a ground transmission line signal path that is coupled to the ground antenna feed terminal. This example is merely illustrative and, in general, antennas 40 may be fed using any desired antenna feeding scheme.

Each radio-frequency transmission line path 46 may include one or more radio-frequency transmission lines that are used to route radio-frequency signals within device 10. Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Radio-frequency transmission line paths 46 may also include radio-frequency connectors that couple multiple transmission lines together. Transmission lines in device 10 such as transmission lines in a radio-frequency transmission line path 46 may be integrated into rigid and/or flexible printed circuit boards. In some implementations, radio-frequency transmission line paths such as radio-frequency transmission line path 46 may also include transmission line conductors integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

In performing wireless transmission, baseband circuitry 42 may provide baseband signals to a transceiver 44 over baseband signal path(s) 31. Transceiver 44 (e.g., one or more transmitters in transceiver 44) may include circuitry for converting the baseband signals received from baseband circuitry 42 into corresponding radio-frequency signals. For example, transceiver 44 may include mixer circuitry for up-converting the baseband signals to radio frequencies prior to transmission over antenna(s) 40. Transceiver 44 may also include digital to analog converter (DAC) and/or analog to digital converter (ADC) circuitry for converting signals between digital and analog domains. Transceiver 44 may transmit the radio-frequency signals over antenna(s) 40 via one or more radio-frequency transmission line paths 46 and RFFE circuitry 48. Antenna(s) 40 may transmit the radio-frequency signals to external wireless equipment (e.g., a wireless access point, a wireless base station, another device 10, an accessory device, a peripheral device, a head-mounted device, a communications satellite, etc.) by radiating the radio-frequency signals into free space.

In performing wireless reception, antenna(s) 40 may receive radio-frequency signals from the external wireless equipment. The received radio-frequency signals may be conveyed to a corresponding transceiver 44 via radio-frequency transmission line path(s) 46 and RFFE circuitry 48. Transceiver 44 may include circuitry for converting the received radio-frequency signals into corresponding baseband signals. For example, transceiver 44 may include one or more receivers having mixer circuitry for down-converting the received radio-frequency signals to baseband frequencies prior to conveying the baseband signals to baseband circuitry 42.

RFFE circuitry 48 may include radio-frequency front end components that operate on radio-frequency signals conveyed over the corresponding radio-frequency transmission line path(s) 46. RFFE circuitry 48 may include one or more RFFE modules. Each RFFE module may include corresponding radio-frequency components for operating on radio-frequency signals within a corresponding set of one or more frequency bands and/or for a corresponding set of one or more antennas 40. RFFE circuitry 48 may sometimes also be referred to herein simply as radio-frequency front end 48.

Each RFFE module in RFFE circuitry 48 may include corresponding radio-frequency components mounted a different respective substrate such as a printed circuit board substrate (e.g., a rigid or flexible printed circuit board). If desired, one or more of the RFFE modules may be a multi-chip module (MCM). The radio-frequency components of each RFFE module may be formed from one or more integrated circuits and/or surface mount components (e.g., surface mount technology (SMT) components) mounted (e.g., soldered) to the corresponding substrate of that RFFE module, may be printed onto the substrate, may be embedded within the substrate, etc. Each RFFE module may include respective control circuitry, a respective control interface, a respective power interface (e.g., power supply pins), respective I/O pins, a respective digital interface, etc.

The radio-frequency front end components in each RFFE module of RFFE circuitry 48 may include switching circuitry (e.g., one or more radio-frequency switches), radio-frequency filter circuitry (e.g., low pass filters, high pass filters, notch filters, band pass filters, multiplexing circuitry, duplexer circuitry, diplexer circuitry, triplexer circuitry, switchplexer circuitry, etc.), impedance matching circuitry (e.g., circuitry that helps to match the impedance of antenna(s) 40 to the impedance of radio-frequency transmission line path(s) 46, circuitry that helps to match the impedance of some components in RFFE circuitry 48 to other components in RFFE circuitry 48, etc.), antenna tuning circuitry (e.g., networks of capacitors, resistors, inductors, and/or switches that adjust the frequency response of antennas 40), radio-frequency amplifier circuitry (e.g., power amplifier (PA) circuitry such as one or more power amplifiers and/or low-noise amplifier (LNA) circuitry such as one or more low noise amplifiers), radio-frequency (RF) coupler circuitry, power detector (PD) circuitry such as one or more power detectors 38, charge pump circuitry, power management circuitry, low dropout (LDO) regulator circuitry, digital control and interface circuitry, and/or any other desired circuitry that operates on the radio-frequency signals transmitted and/or received by the antenna(s) 40 coupled to RFFE circuitry 48 over the corresponding radio-frequency transmission line path(s) 46.

While control circuitry 28 is shown separately from wireless circuitry 38 in the example of FIG. 2 for the sake of clarity, wireless circuitry 38 may include processing circuitry that forms a part of processing circuitry 32 and/or storage circuitry that forms a part of storage circuitry 30 of control circuitry 28 (e.g., portions of control circuitry 28 may be implemented on wireless circuitry 38). As an example, baseband circuitry 42 and/or portions of transceiver(s) 44(e.g., a host processor on transceiver(s) 44) may form a part of control circuitry 28.

Wireless circuitry 38 may transmit and/or receive wireless signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), a Wi-Fi® 7 band, and/or other Wi-Fi® bands (e.g., from 1875-5160 MHz), wireless personal area network (WPAN) frequency bands such as the 2.4 GHz Bluetooth® band or other WPAN communications bands, cellular telephone communications bands such as a cellular low band (LB) (e.g., a band between about 600 to 960 MHz), a cellular low-midband (LMB) (e.g., a band between about 1400 to 1550 MHz), a cellular midband (MB) (e.g., a band between about 1700 to 2200 MHz), a cellular high band (HB) (e.g., a band between 2300 to 2700 MHz), a cellular ultra-high band (UHB) (e.g., a band from 3300 to 5000 MHz, or other cellular communications bands between about 600 MHz and about 5000 MHz), 3G bands, 4G LTE bands, 5G New Radio Frequency Range 1 (FR1) bands below 7.125 GHz, 3GPP Frequency Range 2 (FR2) bands between 24.25 GHz and around 75 GHz (e.g., one or more 5G and/or 6G bands in FR2), 3GPP Frequency Range 3 (FR3) bands between 7.125 GHz and 24.25 GHz (e.g., one or more 6G bands in FR3), and/or other centimeter or millimeter wave frequency bands between 10-100 GHz that support a cellular telephone communications protocol, sub-THz bands between around 100 GHz and around 10 THz, near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, ultra-wideband (UWB) frequency bands that operate under the IEEE 802.15.4 protocol and/or other ultra-wideband communications protocols (e.g., a first UWB communications band at 6.5 GHz and/or a second UWB communications band at 8.0 GHz), communications bands under the IEEE 802.XX family of standards, satellite communications bands such as an L-band, S-band (e.g., from 2-4 GHz), C-band (e.g., from 4-8 GHz), X-band, Ku-band (e.g., from 12-18 GHz), Ka-band (e.g., from 26-40 GHz), etc., industrial, scientific, and medical (ISM) bands such as an ISM band between around 900 MHz and 950 MHz or other ISM bands below or above 1 GHz, one or more unlicensed bands, one or more bands reserved for emergency and/or public services, and/or any other desired frequency bands of interest.

Antennas 40 may be formed using any desired antenna structures. For example, antennas 40 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Parasitic elements may be included in antennas 40 to adjust antenna performance.

Filter circuitry, switching circuitry, impedance matching circuitry, and other circuitry may be interposed within radio-frequency transmission line path(s) 46, may be incorporated into RFFE circuitry 48, and/or may be incorporated into antenna(s) 40 (e.g., to support antenna tuning, to support operation in desired frequency bands, etc.). These components, sometimes referred to herein as antenna tuning components, may be adjusted (e.g., using control circuitry 28) to adjust the frequency response and wireless performance of antennas 40 over time.

In general, each transceiver 44 may cover (handle) any suitable communications (frequency) bands of interest. The transceiver may convey radio-frequency signals using antenna(s) 40 (e.g., antenna(s) 40 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antennas 40 may transmit the radio-frequency signals by radiating the radio-frequency signals into free space (or to free space through intervening device structures such as a dielectric cover layer). Antennas 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antennas.

In examples where multiple antennas 40 are arranged in a phased antenna array, each antenna 40 may form a respective antenna element of the phased antenna array. Conveying radio-frequency signals using the phased antenna array may allow for greater peak signal gain relative to scenarios where individual antennas 40 are used to convey radio-frequency signals. In satellite navigation system links, cellular telephone links, and other long-range links, radio-frequency signals are typically used to convey data over thousands of feet or miles. In Wi-Fi® and Bluetooth® links at 2.4 and 5 GHz and other short-range wireless links, radio-frequency signals are typically used to convey data over tens or hundreds of feet. In scenarios where FR2 and/or FR3 bands are used to convey radio-frequency signals, a phased antenna array may convey radio-frequency signals over short distances that travel over a line-of-sight path. To enhance signal reception for millimeter and centimeter wave communications, the phased antenna array may convey radio-frequency signals using beam steering techniques (e.g., schemes in which antenna signal phase and/or magnitude for each antenna in an array are adjusted to perform beam steering).

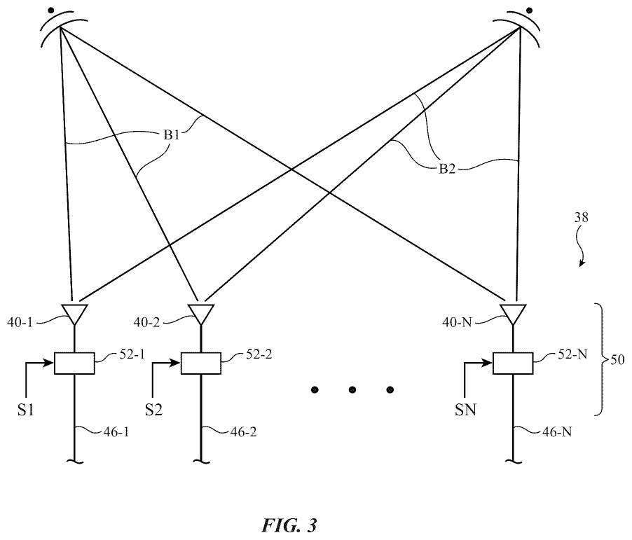

FIG. 3 shows how multiple antennas 40 may form a corresponding phased antenna array 50. As shown in FIG. 3, phased antenna array 50 (sometimes referred to herein as array 50, antenna array 50, or array 50 of antennas 40) may be coupled to radio-frequency transmission line paths 46. For example, a first antenna 40-1 in phased antenna array 50 may be coupled to a first radio-frequency transmission line path 46-1, a second antenna 40-2 in phased antenna array 50 may be coupled to a second radio-frequency transmission line path 46-2, an Nth antenna 40-N in phased antenna array 50 may be coupled to an Nth radio-frequency transmission line path 46-N, etc. Although antennas 40 are described herein as forming a phased antenna array, the antennas 40 in phased antenna array 50 are sometimes also referred to as collectively forming a single phased array antenna (e.g., where antennas 40 form antenna elements of the phased array antenna).

Antennas 40 in phased antenna array 50 may be arranged in any desired number of rows and columns or in any other desired pattern (e.g., the antennas need not be arranged in a grid pattern having rows and columns). Each antenna 40 may be separated from one or more adjacent antennas 40 in phased antenna array 50 by a predetermined distance such as approximately half an effective wavelength of operation of the array. During signal transmission operations, radio-frequency transmission line paths 46 may be used to supply signals (e.g., radio-frequency signals such as millimeter wave and/or centimeter wave signals) from transceiver circuitry to phased antenna array 50 for wireless transmission. During signal reception operations, radio-frequency transmission line paths 46 may be used to supply signals received at phased antenna array 50 (e.g., from external wireless equipment or transmitted signals that have been reflected off of external objects) to transceiver circuitry.

The use of multiple antennas 40 in phased antenna array 50 allows beam forming/steering arrangements to be implemented by controlling the relative phases and magnitudes (amplitudes) of the radio-frequency signals conveyed by the antennas. In the example of FIG. 3, antennas 40 each have a corresponding radio-frequency phase and magnitude controller 52 (e.g., a first phase and magnitude controller 52-1 disposed on radio-frequency transmission line path 46-1 may control phase and magnitude for radio-frequency signals handled by antenna 40-1, a second phase and magnitude controller 52-2 disposed on radio-frequency transmission line path 46-2 may control phase and magnitude for radio-frequency signals handled by antenna 40-2, an Nth phase and magnitude controller 52-N disposed on radio-frequency transmission line path 46-N may control phase and magnitude for radio-frequency signals handled by antenna 40-N, etc.).

Phase and magnitude controllers 52 may each include circuitry for adjusting the phase of the radio-frequency signals on radio-frequency transmission line paths 46 (e.g., phase shifter circuits) and/or circuitry for adjusting the magnitude of the radio-frequency signals on radio-frequency transmission line paths 46 (e.g., power amplifier and/or low noise amplifier circuits). Phase and magnitude controllers 52 may sometimes be referred to collectively herein as beam steering circuitry or beam forming circuitry (e.g., beam steering/forming circuitry that steers/forms the beam of radio-frequency signals transmitted and/or received by phased antenna array 50).

Phase and magnitude controllers 52 may adjust the relative phases and/or magnitudes of the transmitted signals that are provided to each of the antennas (e.g., to produce constructive and/or destructive interference causing the signals to exhibit peak magnitude in a desired direction) in phased antenna array 50 and may adjust the relative phases and/or magnitudes of the received signals that are received by phased antenna array 50 (e.g., such that the signals received by each antenna coherently sum together given the incident angle of the signals upon the array). Phase and magnitude controllers 52 may, if desired, include phase detection circuitry for detecting the phases of the received signals that are received by phased antenna array 50. The term “beam” or “signal beam” may be used herein to collectively refer to wireless signals that are transmitted and/or received by phased antenna array 50 in a particular direction. Each beam may exhibit a peak gain that is oriented in a respective beam pointing direction at a corresponding beam pointing angle (e.g., based on constructive and destructive interference from the combination of signals from each antenna in the phased antenna array). Different sets of phase and magnitude settings for phase and magnitude controllers 52 may configure phased antenna array 50 to form different beams in different beam pointing directions.

If, for example, phase and magnitude controllers 52 are adjusted to produce a first set of phases and/or magnitudes, the signals will form a beam as shown by beam B1 of FIG. 3 that is oriented in the direction of point A. If, however, phase and magnitude controllers 52 are adjusted to produce a second set of phases and/or magnitudes, the signals will form a beam as shown by beam B2 that is oriented in the direction of point B. Each phase and magnitude controller 52 may be controlled to produce a desired phase and/or magnitude based on a corresponding control signal S received from control circuitry 28 of FIG. 1 (e.g., the phase and/or magnitude provided by phase and magnitude controller 52-1 may be controlled using control signal S1, the phase and/or magnitude provided by phase and magnitude controller 52-2 may be controlled using control signal S2, the phase and/or magnitude provided by phase and magnitude controller 52-N may be controlled using control signal SN, etc.). If desired, the control circuitry may actively adjust control signals S in real time to steer (form) the beam in different desired directions over time. Phase and magnitude controllers 52 may provide information identifying the phase of received signals to control circuitry 28 if desired.

When performing wireless communications using radio-frequency signals at relatively high frequencies such as frequencies greater than around 10 GHz, radio-frequency signals may be conveyed over a line-of-sight path between phased antenna array 50 and external communications equipment. If the external equipment is located at point A of FIG. 3, phase and magnitude controllers 52 may be adjusted to steer the signal beam towards point A (e.g., to steer the pointing direction of the signal beam towards point A). Phased antenna array 50 may transmit and receive radio-frequency signals in the direction of point A. Similarly, if the external equipment is located at point B, phase and magnitude controllers 52 may be adjusted to steer the signal beam towards point B (e.g., to steer the pointing direction of the signal beam towards point B). Phased antenna array 50 may transmit and receive radio-frequency signals in the direction of point B.

In the example of FIG. 3, beam steering is shown as being performed over a single degree of freedom for the sake of simplicity (e.g., towards the left and right on the page of FIG. 3). However, in practice, the beam may be steered over two or more degrees of freedom (e.g., in three dimensions, into and out of the page and to the left and right on the page of FIG. 3). In these implementations, the antennas 40 in phased antenna array 50 may be arranged in a two-dimensional pattern. Phased antenna array 50 may have a corresponding field of view over which beam steering can be performed (e.g., in a hemisphere or a segment of a hemisphere over the phased antenna array).

The antennas 40 in phased antenna array 50 may be unpolarized antennas that convey unpolarized radio-frequency signals, may be single-polarization antennas that convey radio-frequency signals with a single polarization, or may be dual-polarization antennas that concurrently convey radio-frequency signals with two orthogonal polarizations. Implementations in which the antennas 40 in phased antenna array 50 are dual-polarization antennas that convey radio-frequency signals with orthogonal linear polarizations (e.g., a vertical linear polarization V and a horizontal linear polarization H) are described herein as an example. Each polarization may, if desired, convey a different respective stream of wireless data (e.g., maximizing data throughput). Alternatively, both polarizations may convey the same stream of wireless data (e.g., to provide polarization diversity for the stream of wireless data).

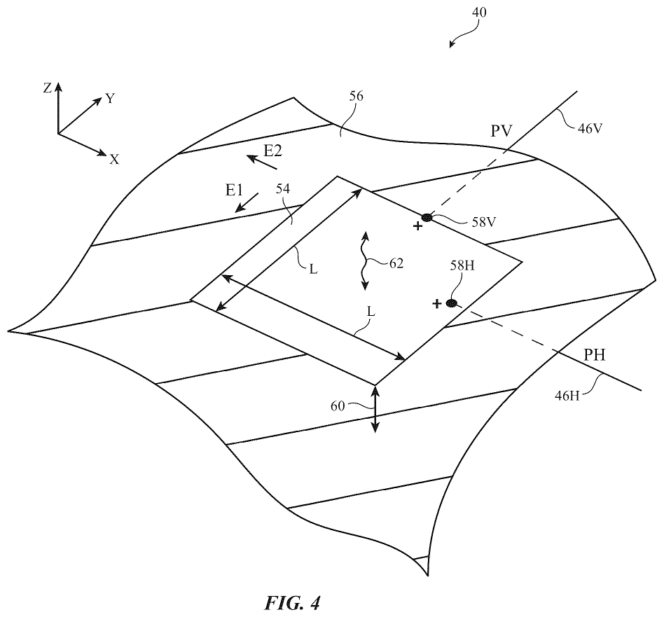

FIG. 4 is a perspective view showing one example of how an antenna 40 in phased antenna array 50 may be implemented as a dual-polarization antenna. In the example of FIG. 4, antenna 40 is illustrated as a dual-polarized patch antenna. This is illustrative and non-limiting and, if desired, antenna 40 may be a dual-polarized slot antenna, a dual-polarized inverted-F antenna, a dual-polarized dielectric resonator antenna, a dual-polarized dipole antenna, a dual-polarized bowtie antenna, or any other desired type of dual-polarized antenna (e.g., having orthogonal radiating edges fed by respective transmission line paths).

As shown in FIG. 4, antenna 40 may have an antenna resonating element 54 and a corresponding antenna ground 56. Antenna resonating element 54 may include a conductive patch that extends parallel to antenna ground 56 and that is separated from antenna ground 56 by distance 60 (e.g., antenna resonating element 54 may lie within a plane such as the X-Y plane of FIG. 4). Antenna resonating element 54 and antenna ground 56 may be formed from conductive traces patterned on a dielectric substrate such as a rigid or flexible printed circuit board substrate, metal foil, stamped sheet metal, electronic device housing structures, or any other desired conductive structures.

The length of the sides of antenna resonating element 54 may be selected so that antenna 40 resonates at a desired operating frequency. For example, the sides of antenna resonating element 54 may each have a length L that is approximately equal to half of the effective wavelength of the signals conveyed by antenna 40 (e.g., where effective wavelength is equal to a vacuum wavelength multiplied a constant based on the dielectric materials surrounding antenna resonating element 54). As just one example, length L may be between 0.8 mm and 1.2 mm (e.g., approximately 1.1 mm) for covering an FR2 band between 57 GHz and 70 GHz.

The example of FIG. 4 is illustrative and non-limiting. Antenna resonating element 54 may have a square shape in which all of the sides of the antenna resonating element are the same length or may have a different rectangular shape. Antenna resonating element 54 may be formed in other shapes having any desired number of straight and/or curved edges. If desired, antenna resonating element 54 and antenna ground 56 may have different shapes and relative orientations.

To enhance the polarizations handled by antenna 40, antenna 40 may be provided with multiple feeds. As shown in FIG. 4, antenna 40 may have a first feed at antenna port PV that is coupled to a first radio-frequency transmission line path 46V. Antenna 40 may have a second feed at antenna port PH that is coupled to a second radio-frequency transmission line path 46H. The first antenna feed may have a first ground feed terminal coupled to antenna ground 56 (not shown in FIG. 4 for the sake of clarity) and a first positive feed terminal 58V coupled to antenna resonating element 54. The second antenna feed may have a second ground feed terminal coupled to antenna ground 56 (not shown in FIG. 4 for the sake of clarity) and a second positive feed terminal 58H coupled to antenna resonating element 54.

Holes or openings such as openings may be formed in antenna ground 56 if desired. Radio-frequency transmission line path 46V may include a vertical conductor (e.g., a conductive through-via, conductive pin, metal pillar, solder bump, combinations of these, or other vertical conductive interconnect structures) that extends through a hole (not shown) in antenna ground 56 to positive antenna feed terminal 58V. Radio-frequency transmission line path 46H may include a vertical conductor that extends through a hole (not shown) in antenna ground 56 to positive antenna feed terminal 58H. This example is illustrative and, if desired, other transmission line structures may be used (e.g., coaxial cable structures, stripline transmission line structures, etc.).

When using the antenna feed associated with port PV (i.e., the antenna feed that includes positive antenna feed terminal 58V), antenna 40 may transmit and/or receive radio-frequency signals having a first polarization (e.g., the electric field E1 of antenna signals 62 associated with port PV may be oriented parallel to the Y-axis in FIG. 4). When using the antenna feed associated with port PH (i.e., the antenna feed that includes positive antenna feed terminal 58H), antenna 40 may transmit and/or receive radio-frequency signals having a second polarization (e.g., the electric field E2 of antenna signals 62 associated with port PH may be oriented parallel to the X-axis of FIG. 4 so that the polarizations associated with ports P1 and P2 are orthogonal to each other).

In scenarios such as these where the first polarization is linear and orthogonal to the second polarization (which is also linear), radio-frequency signals handled by port PV may sometimes be referred to herein as vertical polarization signals or vertically polarized signals whereas radio-frequency signals handled by port PH may sometimes be referred to herein as horizontal polarization signals or horizontally polarized signals. Radio-frequency transmission line path 46V carries vertically polarized signals and is sometimes also referred to herein as vertically polarized radio-frequency transmission line path 46V. Radio-frequency transmission line path 46H carries horizontally polarized signals and is sometimes also referred to herein as horizontally polarized radio-frequency transmission line path 46H. Positive antenna feed terminal 58V feeds vertically polarized signals for antenna 40 and is sometimes also referred to herein as vertically polarized positive antenna feed terminal 58V. Positive antenna feed terminal 58H feeds horizontally polarized signals for antenna 40 and is sometimes also referred to herein as horizontally polarized positive antenna feed terminal 58H. As used herein, the terms “vertical” and “horizontal” refer to the relative orientation between the signals handled by ports PH and PV (i.e., orthogonal orientations) and do not refer to the relative orientation of the signals with respect to other components in device 10 or the surroundings of device 10.

One of ports PV and PH may be used at a given time so that antenna 40 operates as a single-polarization antenna or both ports may be operated at the same time so that antenna 40 operates with other polarizations (e.g., as a dual-polarization antenna, a circularly-polarized antenna, an elliptically-polarized antenna, etc.). If desired, the active port may be changed over time so that antenna 40 can switch between covering vertical or horizontal polarizations at a given time. Ports PV and PH may be coupled to different phase and magnitude controllers 52 (FIG. 3) or may both be coupled to the same phase and magnitude controller 52.

The example of FIG. 4 is illustrative and, if desired, antenna 40 may include any two antenna feeds having positive antenna feed terminals 58 coupled to antenna resonating element 54 at any desired locations (e.g., regardless of polarization). If desired, antenna 40 may include one or more parasitic antenna resonating elements that serve to broaden the bandwidth of antenna 40. Antenna 40 need not be a patch antenna and may be implemented as any other type of antenna if desired (e.g., an antenna having two feeds for covering two polarizations).

In some implementations that are described herein as an example, the transceivers 44 in device 10 (FIG. 1) may include a single cellular telephone transceiver 44A (e.g., a single radio or transceiver integrated circuit chip) that conveys radio-frequency signals using a cellular telephone RAT (e.g., a 5G RAT and/or a 6G RAT) in one or more FR2 bands as well as in one or more FR3 bands. In general, the FR3 bands are higher in frequency than FR1 bands and lower in frequency than FR2 bands. More specifically, the FR3 bands are at frequencies between 7.125 GHz and 24.25 GHz whereas the FR2 bands are at frequencies between 24.25 GHz and around 75 GHz and the FR1 bands are at frequencies less than 7.125 GHz. Covering both the FR2 and FR3 bands with the same transceiver 44 may, for example, eliminate the need for an additional transceiver in device 10 to cover the FR3 band(s), helping to reduce space and power consumption in device 10 while also decreasing the design and routing complexity and the cost of device 10.

In these implementations, wireless circuitry 38 may include both a first phased antenna array 50A that conveys radio-frequency signals in one or more of the FR2 bands and a second phased antenna array 50B that conveys radio-frequency signals in one or more of the FR3 bands (e.g., one or more FR3 bands between around 12.7 GHz and 13.25 GHz or other FR3 bands). Both phased antenna arrays may be communicatively coupled to transceiver 44A over a shared RFFE module in RFFE circuitry 48 (FIG. 2).

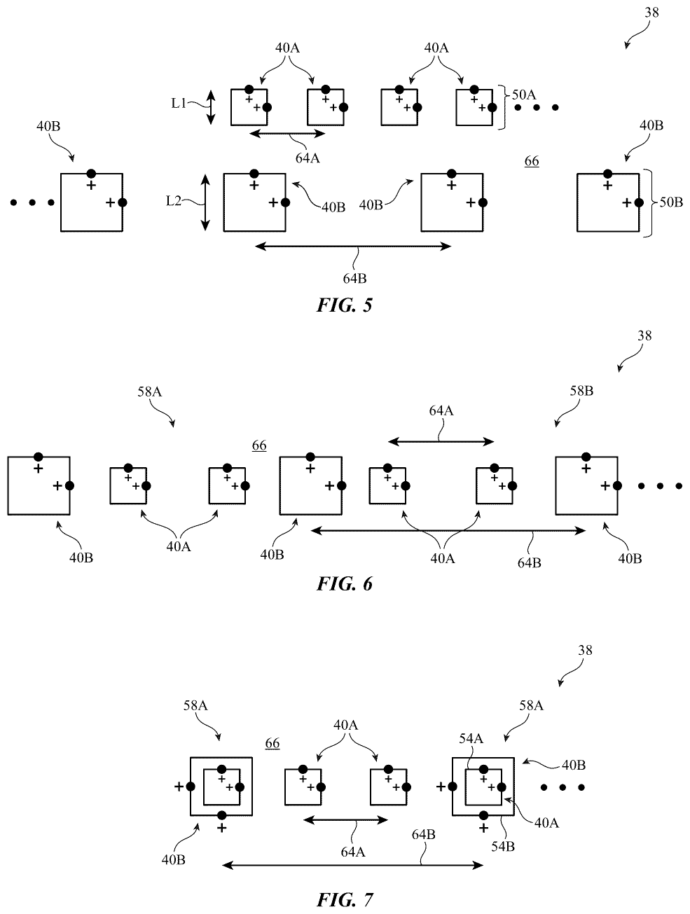

FIG. 5 shows one example of how wireless circuitry 38 may include both a first phased antenna array 50A that forms a first signal beam in the FR2 band(s) and a second phased antenna array 50B that forms a second signal beam in the FR3 band(s). As shown in FIG. 5, phased antenna array 50A may include a set of two or more antennas 40A. Phased antenna array 50B may include a set of two or more antennas 40B. Antennas 40A and 40B may be dual-polarization antennas that each have a corresponding positive antenna feed terminal 58V and a corresponding positive antenna feed terminal 58H (FIG. 4). Alternatively, antennas 40A and/or 40B may be single-polarization antennas.

Antennas 40A and antennas 40B may be mounted to the same underlying substrate 66 (e.g., a rigid or flexible printed circuit board substrate). Alternatively, antennas 40A may be disposed on a different substrate 66 than antennas 40B. Alternatively, the antennas 40A in phased antenna array 50A may be distributed between two or more substrates 66 and/or the antennas 40B in phased antenna array 50B may be distributed between two or more substrates 66.

The antennas 40A in phased antenna array 50A may convey radio-frequency signals in the FR2 band(s) (e.g., with both vertical and horizontal polarizations). The antennas 40B in phased antenna array 50B may convey radio-frequency signals in the FR3 band(s) (e.g., with both vertical and horizontal polarizations). Because the FR3 band(s) are at lower frequencies than the FR2 band(s), the antenna resonating elements of antennas 40B may be larger than the antenna resonating elements of antennas 40A. In addition, the antennas 40A in phased antenna array 50A may be separated by a first distance (spacing) 64A whereas the antennas 40B in phased antenna array 50B are separated by a second distance (spacing) 64B that is larger than first distance 64A.

In the example of FIG. 5, phased antenna array 50A is non-overlapping and offset from phased antenna array 50B. Phased antenna array 50A is illustrated as a one-dimensional array that includes at least four antennas 40A and phased antenna array 50B is illustrated as a one-dimensional array that includes at least four antennas 40B. This is illustrative and non-limiting. If desired, phased antenna array 50B may include two antennas 40B, three antennas 40B, or more than four antennas 40B. The antennas 40B in phased antenna array 50B may be arranged in a two-dimensional pattern if desired. Similarly, phased antenna array 50A may include two antennas 40A, three antennas 40A, or more than four antennas 40A. The antennas 40A in phased antenna array 50A may be arranged in a two-dimensional pattern if desired. Phased antenna arrays 50A and 50B need not have the same number of antennas. The antennas of phased antenna arrays 50A and 50B need not be arranged in the same pattern.

If desired, the antennas 40B in phased antenna array 50B may be interleaved or interspersed with the antennas 40A in phased antenna array 50A. FIG. 6 shows one example of how the antennas 40B in phased antenna array 50B may be interleaved with the antennas 40A in phased antenna array 50B. Depending on the distance 64B between antennas 40B, there may be one, two, or more than two antennas 40A interposed between each pair of adjacent antennas 40B.

In the example of FIG. 6, phased antenna array 50A is illustrated as a one-dimensional array that includes at least four antennas 40A and phased antenna array 50B is illustrated as a one-dimensional array that includes at least three antennas 40B. This is illustrative and non-limiting. If desired, phased antenna array 50B may include two antennas 40B or more than three antennas 40B. The antennas 40B in phased antenna array 50B may be arranged in a two-dimensional pattern if desired. Similarly, phased antenna array 50A may include two antennas 40A or more than three antennas 40A. The antennas 40A in phased antenna array 50A may be arranged in a two-dimensional pattern if desired. Phased antenna arrays 50A and 50B need not have the same number of antennas. The antennas of phased antenna arrays 50A and 50B need not be arranged in the same pattern. In implementations where antennas 40A and antennas 40B are arranged in two dimensional patterns having rows and columns, the rows of antennas 40A may be interleaved with the rows of antennas 40B and/or the columns of antennas 40A may be interleaved with the columns of antennas 40B.

If desired, to help conserve space in device 10, one or more of the antennas 40A in phased antenna array 50A may overlap one or more of the antennas 40B in phased antenna array 50B (e.g., phased antenna array 50A may overlap phased antenna array 50B on substrate 66). FIG. 7 shows one example of how phased antenna array 50A may overlap phased antenna array 50B. As shown in FIG. 7, the antenna resonating element 54A of one or more antennas 40A in phased antenna array 50A may overlap the antenna resonating element 54B respective antennas 40B in phased antenna array 50B. Depending on distance 64A and distance 64B, a different antenna 40B in phased antenna array 50B may overlap every third antenna 40A in phased antenna array 50A (as shown in the example of FIG. 7), may overlap every other antenna 40A in phased antenna array 50A, may overlap every fourth antenna 40A in phased antenna array 50A, etc.

In the example of FIG. 7, phased antenna array 50A is illustrated as a one-dimensional array that includes at least four antennas 40A and phased antenna array 50B is illustrated as a one-dimensional array that includes at least two antennas 40B. This is illustrative and non-limiting. If desired, phased antenna array 50B may include three antennas 40B or more than three antennas 40B. The antennas 40B in phased antenna array 50B may be arranged in a two-dimensional pattern if desired. Similarly, phased antenna array 50A may include two antennas 40A, three antennas 40A, or more than four antennas 40A. The antennas 40A in phased antenna array 50A may be arranged in a two-dimensional pattern if desired. The implementations of FIGS. 5-7 may be combined in any desired manner.

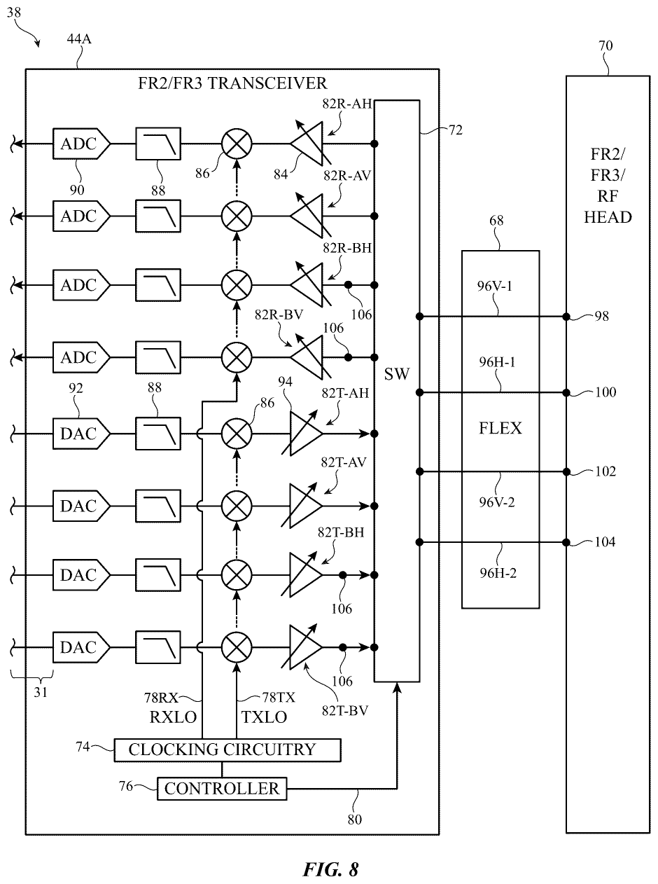

FIG. 8 is a circuit diagram of wireless circuitry 38 in an exemplary implementation in which a single transceiver 44A is used to convey vertically-polarized and horizontally-polarized signals in both the FR2 band(s) and the FR3 band(s) via an integrated (shared) radio-frequency head. Transceiver 44A is sometimes also referred to herein as FR2/FR3 transceiver 44A, FR2/FR3 cellular telephone transceiver 44A, FR2/FR3 radio 44A, FR2/FR3 radio chip 44A, FR2/FR3 transceiver chip 44A, or FR/FR3 integrated circuit 44A. While illustrated herein as conveying cellular telephone signals in the FR2 band(s) and the FR3 band(s), FR2/FR3 transceiver 44A may also convey cellular telephone signals in one or more additional cellular frequency bands if desired (e.g., 3G, 4G, 5G, and/or 6G bands, FR1 bands, etc.).

As shown in FIG. 8, transceiver 44A may be coupled to a radio-frequency head that is shared for both FR2 and FR3 communications, such as single integrated FR2/FR3 RF head 70 (sometimes also referred to herein as FR2/FR3 head 70, RF head 70, or RF circuitry 70). Transceiver 44A may be coupled to RF head 70 over a set of radio-frequency transmission lines such as transmission lines 96 (sometimes also referred to herein as signal paths 96 or data paths 96). If desired, some or all of transmission lines 96 may be disposed on and/or may pass through a substrate such as flexible printed circuit 68. Flexible printed circuit 68 may help to flexibly route transmission lines 96 from transceiver 44A to RF head 70 (e.g., around other components in device 10). RF head 70 may include phased antenna arrays 50A and 50B (FIGS. 5-7) as well as an RFFE module that is shared between phased antenna arrays 50A and 50B for performing both FR2 and FR3 communications.

Transmission lines 96 may include one or more transmission lines 96V that carry vertically polarized radio-frequency signals such as transmission lines 96V-1 and 96V-2. Transmission lines 96 may also include one or more transmission lines 96H that carry horizontally polarized radio-frequency signals such as transmission lines 96H-1 and 96H-2.

Transceiver 44A may include switching circuitry 72. Switching circuitry 72 may include one or more switches and/or multiplexers. Transmission lines 96H-1, 96H-2, 96V-1, and 96V-2 may be coupled in parallel between respective ports (terminals) of switching circuitry 72 and respective ports (terminals) of RF head 70. For example, transmission line 96V-1 may couple a first port of switching circuitry 72 to port 98 of RF head 70. Transmission line 96H-1 may couple a second port of switching circuitry 72 to port 100 of RF head 70. Transmission line 96V-2 may couple a third port of switching circuitry 72 to port 102 of RF head 70. Transmission line 96H-2 may couple a fourth port of switching circuitry 72 to port 104 of RF head 70. Ports 98-104 are sometimes also referred to herein as terminals of RF head 70.

Transceiver 44A may include a set of signal chains 82 coupled in parallel between baseband signal paths 31 and respective ports of switching circuitry 72. Signal chains 82 are sometimes also referred to herein as signal paths 82 or data paths 82. Signal chains 82 may include a set of one or more transmit chains 82T that transmit radio-frequency signals to RF head 70. Transmit chains 82T are sometimes also referred to herein as transmit paths 82T or transmit data paths 82T. Signal chains 82 may also include a set of one or more receive chains 82R that receive radio-frequency signals from RF head 70. Receive chains 82R are sometimes also referred to herein as receive paths 82R or receive data paths 82R.

Each signal chain 82 may include a respective transmission line and one or more components disposed on the transmission line. Each transmit chain 82T may include a corresponding digital-to-analog converter (DAC) 92, one or more filters such as filter 88 (e.g., a low pass filter), one or more mixers such as mixer 86 (e.g., an upconverter), and one or more amplifiers such as power amplifier (PA) 94. The filter 88 on each transmit chain 82T may be coupled between the DAC 92 and the mixer 86 on that transmit chain. The mixer 86 on each transmit chain 82T may be coupled between the filter 88 and the PA 94 on that transmit chain. The PA 94 on each transmit chain 82T may be coupled between the mixer 86 on that transmit chain and a corresponding (transmit) port of switching circuitry 72. Transmit chains 82T may collectively form part of a transmitter in transceiver 44A.

Transmit chains 82T may include a set of one or more transmit chains 82T-A that transmit signals for phased antenna array 50A (FIGS. 5-7) in RF head 70. Transmit chains 82T-A may include at least one vertically polarized transmit chain 82T-AV that transmits vertically polarized signals to the positive antenna feed terminals 58V on the antennas 40A of the phased antenna array 50A in RF head 70. Transmit chains 82T-A may also include at least one horizontally polarized transmit chain 82T-AH that transmits horizontally polarized signals to the positive antenna feed terminals 58H on the antennas 40A of the phased antenna array 50A in RF head 70.

Transmit chains 82T may also include a set of one or more transmit chains 82T-B that transmit radio-frequency signals in the FR3 band(s) for phased antenna array 50B (FIGS. 5-7) in RF head 70. Transmit chains 82T-B may include at least one vertically polarized transmit chain 82T-BV that transmits vertically polarized radio-frequency signals in the FR3 band(s) to the positive antenna feed terminals 58V on the antennas 40B of the phased antenna array 50B in RF head 70. Transmit chains 82T-B may also include at least one horizontally polarized transmit chain 82T-BH that transmits horizontally polarized radio-frequency signals in the FR3 band(s) to the positive antenna feed terminals 58H on the antennas 40B of the phased antenna array 50B in RF head 70.

Each receive chain 82R may include a corresponding analog-to-digital converter (ADC) 90, one or more filters such as filter 88, one or more mixers such as mixer 86 (e.g., a downconverter), and one or more amplifiers such as low noise amplifier (LNA) 84. The filter 88 on each receive chain 82R may be coupled between the ADC 90 and the mixer 86 on that receive chain. The mixer 86 on each receive chain 82R may be coupled between the filter 88 and the LNA 84 on that receive chain. The LNA 84 on each receive chain 82R may be coupled between the mixer 86 on that receive chain and a corresponding (receive) port of switching circuitry 72. Receive chains 82R may collectively form part of a receiver in transceiver 44A.

Receive chains 82R may include a set of one or more receive chains 82R-A that receive radio-frequency signals from phased antenna array 50A (FIGS. 5-7) in RF head 70.

Receive chains 82R-A may include at least one vertically polarized receive chain 82R-AV that receives vertically polarized signals from the positive antenna feed terminals 58V on the antennas 40A of the phased antenna array 50A in RF head 70. Receive chains 82R-A may also include at least one horizontally polarized receive chain 82R-AH that receives horizontally polarized signals from the positive antenna feed terminals 58H on the antennas 40A of the phased antenna array 50A in RF head 70.

Receive chains 82R may also include a set of one or more receive chains 82R-B that receive radio-frequency signals in the FR3 band(s) for phased antenna array 50B (FIGS. 5-7) in RF head 70. Receive chains 82R-B may include at least one vertically polarized receive chain 82R-BV that receives vertically polarized radio-frequency signals in the FR3 band(s) from the positive antenna feed terminals 58V on the antennas 40B of the phased antenna array 50B in RF head 70. Receive chains 82R-B may also include at least one horizontally polarized receive chain 82R-BH that receives horizontally polarized radio-frequency signals in the FR3 band(s) from the positive antenna feed terminals 58H on the antennas 40B of the phased antenna array 50B in RF head 70.

Given that the high frequencies of signals in the FR2 band(s) are subject to substantial signal attenuation, receive chains 82R-AV and 82R-AH may receive signals from RF head 70 at intermediate frequencies and transmit chains 82T-AV and 82T-AH may transmit signals to RF head 70 at the intermediate frequencies rather than frequencies in the FR2 band(s). The signals received by receive chains 82R-AV and 82R-AH and transmitted by transmit chains 82T-AV and 82T-AH are therefore sometimes referred to herein as intermediate frequency (IF) signals. Conveying signals through flexible printed circuit 68 at intermediate frequencies may serve to reduce signal attenuation between transceiver 44A and RF head 70 relative to implementations where the signals are conveyed through flexible printed circuit 68 in the FR2 band(s).

The intermediate frequencies of the IF signals are radio frequencies that are close to (e.g., within 1-20 GHz of) the radio frequencies of the FR2 band(s), which may allow a single transceiver to up or downconvert both FR3 frequencies and intermediate frequencies for the FR2 frequencies. The intermediate frequencies may be lower than the FR3 band(s), higher than the FR3 band(s) and lower than the FR2 band(s), within 1-20 GHz of the FR3 band(s), less than 10 GHz, less than 5 GHz, less than 2 GHz, less than 1 GHz, less than 20 GHz, less than 25 GHz, less than 15 GHz, or other frequencies lower than the FR2 band(s), as examples. The RFFE module in RF head 70 may include additional mixer circuitry that upconverts the IF signals output by transmit chains 82T-AV and 82T-AH to the FR2 band(s) prior to transmission by phased antenna array 50A. The RFFE module in RF head 70 may also include additional mixer circuitry that downconverts signals received by phased antenna array 50A from the FR2 band(s) to the intermediate frequencies prior to passing IF signals to receive chains in transceiver 44A. On the other hand, because the FR3 band(s) are at lower frequencies than the FR2 band(s) and are therefore subject to less signal attenuation, transmit chains 82T-BV and 82T-BH may output signals in the FR3 band(s) and receive chains 82R-BV and 82R-BH may receive signals from RF head 70 in the FR3 band(s). Radio-frequency signals that are at a frequency in an FR3 band are sometimes referred to herein as FR3 signals. Radio-frequency signals that are at a frequency in an FR2 band are sometimes referred to herein as FR2 signals.

Transceiver 44A may include clocking circuitry 74 that is used for both FR2 and FR3 communications (e.g., clocking circuitry 74 may clock signal transmission and reception by signal chains 82R-AH, 82R-AV, 82R-BH, 82R-BV, 82T-AH, 82T-AV, 82T-BH, and 82T-BV). Clocking circuitry 74 may include one or more voltage controlled oscillators (VCOs), one or more local oscillators (LOs), one or more phase locked loops (PLLs), one or more frequency locked loops (FLLs), one or more self-injection locking loops, one or more low-dropout (LDO) regulators, one or more crystal oscillators, and/or any other desired clocking circuitry. Because the lower frequencies of the FR2 band(s) (e.g., around 20-30 GHz) are close in frequency to the FR3 band(s), the same VCO in clocking circuitry 74 may be shared between the IF (FR2) chains (e.g., signal chains 82R-AH, 82R-AV, 82T-AH, and 82T-AV) and the FR3 chains (e.g., signal chains 82R-BH, 82R-BV, 82T-BH, and 82T-BV) in transceiver 44A if desired.

Clocking circuitry 74 may, for example, transmit one or more clocking signals RXLO to the mixers 86 on receive chains 82R-AH, 82R-AV, 82R-BH, and 82R-BV over clocking path 78RX. During signal reception, the mixers 86 on receive chains 82R-AH and 82R-AV may downconvert IF signals received from RF head 70 to baseband by mixing the IF signals with a clocking signal RXLO. During signal reception, the mixers 86 on receive chains 82R-BH and 82R-BV may downconvert signals received from RF head 70 from the FR3 band(s) to baseband by mixing the signals with a clocking signals RXLO. Receive chains 82R-AH, 82R-AV, 82R-BH, and 82R-BV may output baseband signals onto respective baseband signal paths 31.

If desired, the mixers 86 on receive chains 82R-BH and 82R-BV may downconvert FR3 signals received from RF head 70 using the same clocking signal RXLO used by the mixers 86 on receive chains 82R-AH and 82R-AV to downconvert IF signals. Alternatively, the mixers 86 on receive chains 82R-BH and 82R-BV may downconvert signals received from RF head 70 using a first clocking signal RXLO whereas the mixers 86 on receive chains 82R-AH and 82R-AV downconvert IF signals received from RF head 70 using a second clocking signal RXLO (e.g., a clocking signal RXLO at a different frequency than the first clocking signal RXLO).

Clocking circuitry 74 may also transmit one or more clocking signals TXLO to the mixers 86 on transmit chains 82T-AH, 82T-AV, 82T-BH, and 82T-BV over clocking path 78TX. Transmit chains 82T-AH, 82T-AV, 82T-BH, and 82T-BV may receive corresponding baseband signals (e.g., containing one, two, three, or four parallel streams of wireless data) over respective baseband signal paths 31. During signal transmission, the mixers 86 on transmit chains 82T-AH and 82T-AV may upconvert baseband signals to produce IF signals transmitted to RF head 70 by mixing the baseband signals with a clocking signal TXLO. During signal transmission, the mixers 86 on transmit chains 82T-BH and 82T-BV may upconvert baseband signals to produce FR3 signals transmitted to RF head 70 by mixing the baseband signals with a clocking signal TXLO.

If desired, the mixers 86 on transmit chains 82T-BH and 82T-BV may upconvert baseband signals using the same clocking signal RXLO used by the mixers 86 on transmit chains 82T-AH and 82R-TV to produce IF signals. Alternatively, the mixers 86 on transmit chains 82T-BH and 82T-BV may upconvert baseband signals using a first clocking signal TXLO whereas the mixers 86 on transmit chains 82T-AH and 82T-AV upconvert baseband signals using a second clocking signal TXLO (e.g., a clocking signal TXLO at a different frequency than the first clocking signal TXLO).

LNAs 84 may amplify IF signals and/or FR3 signals received from RF head 70 via switching circuitry 72. PAs 94 may amplify IF signals and/or FR3 signals transmitted to RF head 70 through switching circuitry 72. ADCs 90 may convert baseband signals from the analog domain into the digital domain prior to passing the baseband signals onto baseband signal paths 31. DACs 92 may convert baseband signals received over baseband signal paths 31 from the digital domain into the analog domain. Filters 88 may filter the baseband signals on signal paths 82 (e.g., removing high frequency noise or spurs, undesired harmonics, etc.).

Transceiver 44A may include control circuitry such as controller 76. Controller 76 may, for example, form a part of control circuitry 28 (FIG. 1). Controller 76 may be clocked using clocking circuitry 74 if desired. If desired, the LNAs 84 and/or the PAs 94 on transceiver 44A may be adjustable amplifiers that receive a bias or power supply voltage that controls, sets, or adjusts the gain of the amplifiers. If desired, controller 76 may supply LNAs 84 and/or PAs 94 with one or more bias and/or power supply voltages. Controller 76 may adjust the bias and/or power supply voltages to adjust the gain of LNAs 84 and/or PAs 94 over time (e.g., as required to ensure satisfactory levels of wireless performance).

Switching circuitry 72 may selectively couple one or more of signal chains 82R-AH, 82R-BH, 82T-AH, and 82T-BH to one or both of transmission lines 96H-1 and 96H-2 and/or may selectively couple one or more of signal chains 82R-AV, 82R-BV, 82T-AV, and 82T-BV to one or both of transmission lines 96V-1 and 96V-2. Transmission lines 96V-1 and 96V-2 may each convey vertically polarized FR3 signals for signal chains 82R-BV and/or 82T-BV and/or vertically polarized IF signals for signal chains 82T-AV and/or 82T-AV at any given time. Transmission lines 96H-1 and 96H-2 may each convey horizontally polarized FR3 signals for signal chains 82R-BH and/or 82T-BH and/or horizontally polarized IF signals for signal chains 82R-AH and/or 82T-AH at any given time.

Switching circuitry 72 may adjust which of signal chains 82R-AH, 82R-AV, 82R-BH, 82R-BV, 82T-AH, 82T-AV, 82T-BH, and 82T-BV are coupled to which of transmission lines 96V-1, 96H-1, 96V-2, and 96H-2 over time based on the signal transmission and/or reception requirements of transceiver 44A. When a signal chain is coupled to a transmission line 96 by switching circuitry 72, that signal chain is sometimes also referred to herein as being active, enabled, or turned on. An active signal chain may convey signals between baseband paths 31 and RF head 70. When a signal chain is not coupled to any transmission line 96 by switching circuitry 72, that signal chain is sometimes also referred to herein as being inactive, disabled, or turned off. An inactive signal chain does not convey signals between baseband paths 31 and RF head 70.

Switching circuitry 72 may selectively activate one or more of signal chains 82R-AH, 82R-AV, 82R-BH, 82R-BV, 82T-AH, 82T-AV, 82T-BH, and 82T-BV, causing transceiver 44A to concurrently transmit vertically polarized IF signals (e.g., using transmit chain 82T-AV), transmit horizontally polarized IF signals (e.g., using transmit chain 82T-AH), transmit vertically polarized FR3 signals (e.g., using transmit chain 82T-BV), transmit horizontally polarized FR3 signals (e.g., using transmit chain 82T-BH), receive vertically polarized IF signals (e.g., using receive chain 82R-AV), receive horizontally polarized IF signals (e.g., using receive chain 82R-AH), receive vertically polarized FR3 signals (e.g., using receive chain 82R-BV), and/or receive horizontally polarized FR3 signals (e.g., using receive chain 82R-BH) at any given time. Controller 76 may provide a control signal to switching circuitry 72 over control path 80 that controls switching circuitry 72 to selectively couple none, one, more than one, or all of the signal paths to one, more than one, or all of transmission lines 96 at any given time. Controller 76 may use the control signal to change which signal chains are active over time.

The components of transceiver 44A may all be formed on the same shared substrate, rigid or flexible printed circuit board, integrated circuit chip, system on chip (SOC), and/or chip package. Transceiver 44A may have respective data ports, terminals, and/or pins coupled to each transmission line 96. The example of FIG. 8 is illustrative and non-limiting. One or more of signal chains 82 may be omitted if desired. Transceiver 44A may include additional signal chains 82 if desired. In implementations where the phased antenna arrays in RF head 70 include single-polarization antennas, half of the signal chains 82 in transceiver 44A may be omitted. If desired, additional components may be disposed at any desired locations on one or more of signal chains 82.

The phase and magnitude controllers 52 (FIG. 3) for the FR2 signals conveyed by phased antenna array 50A (FIGS. 5-7) may be disposed on RFFE module in RF head 70. If desired, the phase and magnitude controllers 52 (FIG. 3) for the FR3 signals conveyed by phased antenna array 50B and signal paths 82R-BH, 82R-BV, 82T-BH, and 82T-BV may be included within transceiver 44A. In some implementations, the phase and magnitude controllers 52 for the FR3 signals may operate in the analog domain. In these implementations, signal paths 82R-BH, 82R-BV, 82T-BH, and 82T-BV may each include a respective phase and magnitude controller 52 between its corresponding mixer 86 and switching circuitry 72, such as at locations 106. In other implementations, the phase and magnitude controllers 52 for the FR3 signals may operate in the digital domain. In these implementations, if desired, clocking circuitry 74 may clock signal paths 82R-BH, 82R-BV, 82T-BH, and 82T-BV in a manner that imparts the FR3 signals with desired phases and magnitudes similar to phase and magnitude controllers 52 of FIG. 3. If desired, DACs 92 may be implemented as radio-frequency DACs (RFDACs) that perform digital-to-analog conversion in addition to upconversion. In further implementations, the phase and magnitude controllers 52 for the FR3 signals may be disposed on the RFFE module in RF head 70.

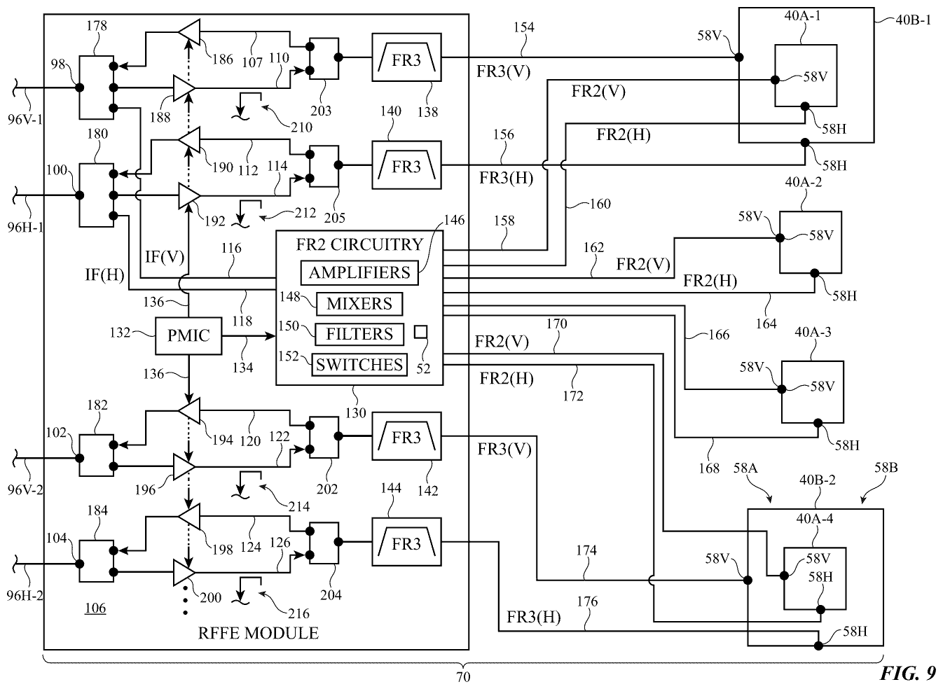

FIG. 9 is a circuit diagram of RF head 70 (e.g., an integrated FR2/FR3 RF head). As shown in FIG. 9, RF head 70 may include phased antenna arrays 58A and 58B. RF head 70 may also include an RFFE module 108 coupled between transmission lines 96 and phased antenna arrays 58A and 58B. RFFE module 108 may be an integrated RFFE module that is shared by both FR2 and FR3 communications using transceiver 44A (FIG. 8). The components of RFFE module 108 may all be mounted to a shared or common substrate 106 such as a semiconductor substrate, a printed circuit board, a package substrate, etc. Phased antenna arrays 50A and 50B are external to RFFE module 108 and may be mounted to one or more substrates that are different than substrate 106 (see, e.g., substrate 66 of FIGS. 5-7).

In the example of FIG. 9, phased antenna array 58A is illustrated as containing four antennas 40A such as antennas 40A-1, 40A-2, 40A-3, and 40A-4. This is illustrative and, if desired, phased antenna array 58A may contain fewer than four antennas 40A or more than four antennas 40A. The antennas 40A in phased antenna array 50A may be arranged in a linear pattern (as shown in FIG. 9) or in a two-dimensional pattern.

In the example of FIG. 9, phased antenna array 58B contains two antennas 40B such as antennas 40B-1 and 40B-2. This is illustrative and, if desired, phased antenna array 58B may contain more than two antennas 40B. In implementations where phased antenna array 58B contains more than two antennas 40B, the circuitry in RFFE module 108 that operates on FR3 signals may be replicated for each additional antenna 40B in phased antenna array 58B. The antennas 40B in phased antenna array 50B may be arranged in a linear pattern (as shown in FIG. 9) or in a two-dimensional pattern. In the example of FIG. 9, phased antenna arrays 50A and 50B are implemented as overlapping to minimize space consumption in device 10. As such, antenna 40A-1 may overlap antenna 40B-1 and antenna 40A-4 may overlap antenna 40B-2. In general, phased antenna arrays 50A and 50B may be implemented using any desired combination of the configurations described in connection with FIGS. 5-7.

Antennas 40A-1, 40A-2, 40A-3, and 40A-4 may each include a respective positive antenna feed terminal 58V that conveys vertically polarized FR2 signals and may each include a respective positive antenna feed terminal 58H that conveys horizontally polarized FR2 signals. Antennas 40B-1 and 40B-2 may each include a respective positive antenna feed terminal 58V that conveys vertically polarized FR3 signals and may each include a respective positive antenna feed terminal 58H that conveys horizontally polarized FR3 signals.

As shown in FIG. 9, RFFE module 108 may include RF switching circuitry such as a first FR2/FR3 selection switch 178 and a second FR2/FR3 selection switch 180. The RF switching circuitry on RFFE module 108 may also include a first transmit/receive switch 203, a second transmit-receive switch 205, a third transmit/receive switch 182, a fourth transmit/receive switch 184, a fifth transmit/receive switch 202, and a sixth transmit/receive switch 204.

RFFE module 108 may include FR2 front end circuitry such as FR2 circuitry 130 (sometimes also referred to herein as FR2 front end 130). FR2 circuitry 130 may include one or more mixers 148 that convert signals between intermediate frequencies and frequencies in the FR2 band(s) (e.g., mixers 148 may convert IF signals into FR2 signals for transmission over phased antenna array 50A and may convert FR2 signals received from phased antenna array 50A into IF signals for transmission to transceiver 44A). FR2 circuitry 130 may include other RF circuitry that operates on IF signals and/or FR2 signals such as amplifiers 146 (e.g., one or more LNAs and one or more PAs), filters 150, and/or switches 152. FR circuitry 130 may also include the phase and magnitude controllers 52 for phased antenna array 50A. If desired, the components of FR2 circuitry 130 may be integrated into a single integrated circuit chip that is mounted to substrate 106 of RFFE module 108 (e.g., where the other components of RFFE module 108 are located external to the integrated circuit chip forming FR2 circuitry 130).

FR2/FR3 selection switch 178 may have a first switch port (terminal) that forms or that is otherwise coupled to port 98 of RFFE module 108. The first switch port may be coupled to transmission line 96V-1. FR2/FR3 selection switch 178 may have a second switch port (terminal) coupled to FR3 receive path 107. FR2/FR3 selection switch 178 may have a third switch port (terminal) coupled to FR3 transmit path 110. FR2/FR3 selection switch 178 may have a fourth switch port (terminal) coupled to FR2 circuitry 130 over IF path 116.

FR2/FR3 selection switch 178 may selectively couple its first switch port (port 98) to one or more of FR3 receive path 107, FR3 transmit path 110, or IF path 116 at a given time. FR2/FR3 selection switch 178 may, for example, have a first switch state in which FR2/FR3 selection switch 178 couples port 98 to FR3 transmit path 110, a second switch state in which FR2/FR3 selection switch 178 couples port 98 to FR3 receive path 107, and a third switch state in which FR2/FR3 selection switch 178 couples port 98 to FR2 circuitry 130 via IF path 116. FR2/FR3 selection switch 178 may, for example, be a single-pole three-throw (SP3T) switch. If desired, FR2/FR3 selection switch 178 may have one or more additional switch states in which FR2/FR3 selection switch 178 concurrently couples port 98 to both IF path 116 and FR3 transmit path 110 and/or FR3 receive path 107.

RFFE module 108 may include an LNA 186 disposed on FR3 receive path 107. RFFE module 108 may include a PA 188 disposed on FR3 transmit path 110. If desired, RFFE module 108 may include a signal coupler 210 disposed on FR3 transmit path 110 between PA 188 and transmit/receive switch 203. Signal coupler 210 may be, for example, a directional switch coupler having a coupled node coupled to a feedback receiver on RFFE module 108 or in transceiver 44A and having an isolated node coupled to one or more impedance terminations. Signal coupler 210 may be used to measure the power of signals conveyed between PA 188 and antenna 40B-1 (e.g., for performing closed-loop power adjustments to PA 188, for measuring the impedance of antenna 40B-1, etc.).

Transmit/receive switch 203 may have a first switch port coupled to FR3 receive path 107. Transmit/receive switch 203 may have a second switch port coupled to FR3 transmit path 110. Transmit/receive switch 203 may have a third switch port coupled to the positive antenna feed terminal 58V of antenna 40B-1 over transmission line 154. If desired, RFFE module 108 may include a filter such as bandpass filter (BPF) 138 disposed on transmission line 154 between transmit/receive switch 203 and antenna 40B-1. BPF 138 may have a passband that overlaps the FR3 band(s) handled by antenna 40B-1.

Transmit/receive switch 203 may selectively couple its third switch port (transmission line 154) to FR3 receive path 107 or FR3 transmit path 110 at a given time. Transmit/receive switch 203 may, for example, have a first switch state in which transmit/receive switch 203 couples transmission line 154 to FR3 transmit path 110 and a second switch state in which transmit/receive switch 203 couples port transmission line 154 to FR3 receive path 107.

Transmission line 154, FR3 transmit path 110, FR3 receive path 107, and transmission line 96V-1 may convey vertically polarized FR3 signals (denoted as FR3(V)) between the active vertically polarized FR3 signal chain(s) in transceiver 44A (FIG. 8) and antenna 40B-1. Transmission line 154, FR3 transmit path 110, FR3 receive path 107, transmission line 96V-1, and the active vertically polarized FR3 signal chain(s) in transceiver 44A may collectively form the radio-frequency transmission line path 46V (FIG. 4) for antenna 40B-1. FR3 transmit path 110, FR3 receive path 107, and IF path 116 may include respective transmission lines on and/or embedded within substrate 106.

FR2/FR3 selection switch 180 may have a first switch port (terminal) that forms or that is otherwise coupled to port 100 of RFFE module 108. The first switch port may be coupled to transmission line 96H-1. FR2/FR3 selection switch 180 may have a second switch port (terminal) coupled to FR3 receive path 112. FR2/FR3 selection switch 180 may have a third switch port (terminal) coupled to FR3 transmit path 114. FR2/FR3 selection switch 180 may have a fourth switch port (terminal) coupled to FR2 circuitry 130 over IF path 118.

FR2/FR3 selection switch 180 may selectively couple its first switch port (port 100) to one or more of FR3 receive path 112, FR3 transmit path 114, or IF path 118 at a given time. FR2/FR3 selection switch 180 may, for example, have a first switch state in which FR2/FR3 selection switch 180 couples port 100 to FR3 transmit path 114, a second switch state in which FR2/FR3 selection switch 180 couples port 100 to FR3 receive path 112, and a third switch state in which FR2/FR3 selection switch 180 couples port 100 to FR2 circuitry 130 via IF path 118. FR2/FR3 selection switch 180 may, for example, be a single-pole three-throw (SP3T) switch. If desired, FR2/FR3 selection switch 180 may have one or more additional switch states in which FR2/FR3 selection switch 180 concurrently couples port 100 to both IF path 118 and FR3 transmit path 114 and/or FR3 receive path 112.

RFFE module 108 may include an LNA 190 disposed on FR3 receive path 112. RFFE module 108 may include a PA 192 disposed on FR3 transmit path 114. If desired, RFFE module 108 may include a signal coupler 212 disposed on FR3 transmit path 114 between PA 192 and transmit/receive switch 205. Signal coupler 212 may be, for example, a directional switch coupler having a coupled node coupled to a feedback receiver on RFFE module 108 or in transceiver 44A and having an isolated node coupled to one or more impedance terminations. Signal coupler 212 may be used to measure the power of signals conveyed between PA 192 and antenna 40B-1 (e.g., for performing closed-loop power adjustments to PA 192, for measuring the impedance of antenna 40B-1, etc.).

Transmit/receive switch 205 may have a first switch port coupled to FR3 receive path 112. Transmit/receive switch 205 may have a second switch port coupled to FR3 transmit path 114. Transmit/receive switch 205 may have a third switch port coupled to the positive antenna feed terminal 58H of antenna 40B-1 over transmission line 156. If desired, RFFE module 108 may include a filter such as BPF 140 disposed on transmission line 156 between transmit/receive switch 205 and antenna 40B-1. BPF 138 may have a passband that overlaps the FR3 band(s) handled by antenna 40B-1.

Transmit/receive switch 205 may selectively couple its third switch port (transmission line 156) to FR3 receive path 112 or FR3 transmit path 114 at a given time. Transmit/receive switch 205 may, for example, have a first switch state in which transmit/receive switch 205 couples transmission line 156 to FR3 transmit path 114 and a second switch state in which transmit/receive switch 205 couples port transmission line 156 to FR3 receive path 112.

Transmission line 156, FR3 transmit path 114, FR3 receive path 112, and transmission line 96H-1 may convey horizontally polarized FR3 signals (denoted as FR3(H)) between the active horizontally polarized FR3 signal chain(s) in transceiver 44A (FIG. 8) and antenna 40B-1. Transmission line 156, FR3 transmit path 114, FR3 receive path 112, transmission line 96H-1, and the active horizontally polarized FR3 signal chain(s) in transceiver 44A may collectively form the radio-frequency transmission line path 46H (FIG. 4) for antenna 40B-1. FR3 transmit path 114, FR3 receive path 112, and IF path 118 may include respective transmission lines on and/or embedded within substrate 106.

Transmit/receive switch 182 may have a first switch port (terminal) that forms or that is otherwise coupled to port 102 of RFFE module 108. The first switch port may be coupled to transmission line 96V-2. Transmit/receive switch 182 may have a second switch port (terminal) coupled to FR3 receive path 120. Transmit/receive switch 182 may have a third switch port (terminal) coupled to FR3 transmit path 122. Unlike FR2/FR3 selection switches 178 and 180, transmit/receive switch 182 does not convey IF signals between transceiver 44A and FR2 circuitry 130.

RFFE module 108 may include an LNA 194 disposed on FR3 receive path 120. RFFE module 108 may include a PA 196 disposed on FR3 transmit path 122. If desired, RFFE module 108 may include a signal coupler 214 disposed on FR3 transmit path 122 between PA 196 and transmit/receive switch 202. Signal coupler 214 may be, for example, a directional switch coupler having a coupled node coupled to a feedback receiver on RFFE module 108 or in transceiver 44A and having an isolated node coupled to one or more impedance terminations. Signal coupler 214 may be used to measure the power of signals conveyed between PA 196 and antenna 40B-2 (e.g., for performing closed-loop power adjustments to PA 196, for measuring the impedance of antenna 40B-2, etc.).

Transmit/receive switch 202 may have a first switch port coupled to FR3 receive path 120. Transmit/receive switch 202 may have a second switch port coupled to FR3 transmit path 122. Transmit/receive switch 202 may have a third switch port coupled to the positive antenna feed terminal 58V of antenna 40B-2 over transmission line 174. If desired, RFFE module 108 may include a filter such as BPF 142 disposed on transmission line 174 between transmit/receive switch 202 and antenna 40B-2. BPF 142 may have a passband that overlaps the FR3 band(s) handled by antenna 40B-2.

Transmit/receive switch 182 may selectively couple its first switch port (port 102) to FR3 receive path 120 or FR3 transmit path 122 at a given time. Transmit/receive switch 182 may, for example, have a first switch state in which transmit/receive switch 182 couples port 102 to FR3 transmit path 122 and a second switch state in which transmit/receive switch 182 couples port 102 to FR3 receive path 120.

Transmit/receive switch 202 may selectively couple its third switch port (transmission line 174) to FR3 receive path 120 or FR3 transmit path 122 at a given time. Transmit/receive switch 202 may, for example, have a first switch state in which transmit/receive switch 202 couples transmission line 174 to FR3 transmit path 122 and a second switch state in which transmit/receive switch 202 couples transmission line 174 to FR3 receive path 120.

Transmission line 174, FR3 transmit path 122, FR3 receive path 120, and transmission line 96V-2 may convey vertically polarized FR3 signals (denoted as FR3(V)) between the active vertically polarized FR3 signal chain(s) in transceiver 44A (FIG. 8) and antenna 40B-2. Transmission line 174, FR3 transmit path 122, FR3 receive path 120, transmission line 96V-2, and the active vertically polarized FR3 signal chain(s) in transceiver 44A may collectively form the radio-frequency transmission line path 46V (FIG. 4) for antenna 40B-2. FR3 transmit path 122 and FR3 receive path 120 may include respective transmission lines on and/or embedded within substrate 106.

Transmit/receive switch 184 may have a first switch port (terminal) that forms or that is otherwise coupled to port 104 of RFFE module 108. The first switch port may be coupled to transmission line 96H-2. Transmit/receive switch 184 may have a second switch port (terminal) coupled to FR3 receive path 124. Transmit/receive switch 184 may have a third switch port (terminal) coupled to FR3 transmit path 126. Unlike FR2/FR3 selection switches 178 and 180, transmit/receive switch 184 does not convey IF signals between transceiver 44A and FR2 circuitry 130.

RFFE module 108 may include an LNA 198 disposed on FR3 receive path 124. RFFE module 108 may include a PA 200 disposed on FR3 transmit path 126. If desired, RFFE module 108 may include a signal coupler 216 disposed on FR3 transmit path 126 between PA 200 and transmit/receive switch 204. Signal coupler 216 may be, for example, a directional switch coupler having a coupled node coupled to a feedback receiver on RFFE module 108 or in transceiver 44A and having an isolated node coupled to one or more impedance terminations. Signal coupler 216 may be used to measure the power of signals conveyed between PA 200 and antenna 40B-2 (e.g., for performing closed-loop power adjustments to PA 200, for measuring the impedance of antenna 40B-2, etc.).

Transmit/receive switch 204 may have a first switch port coupled to FR3 receive path 124. Transmit/receive switch 204 may have a second switch port coupled to FR3 transmit path 126. Transmit/receive switch 204 may have a third switch port coupled to the positive antenna feed terminal 58H of antenna 40B-2 over transmission line 176. If desired, RFFE module 108 may include a filter such as BPF 144 disposed on transmission line 176 between transmit/receive switch 204 and antenna 40B-2. BPF 144 may have a passband that overlaps the FR3 band(s) handled by antenna 40B-2. BPFs 138, 140, 142, and 144 may, for example, help to prevent the FR2 signals and the IF signals conveyed by FR2 circuitry 130 from producing interference or cross-talk in the FR3 signals conveyed by antennas 40B-1 and 40B-2.

Transmit/receive switch 184 may selectively couple its first switch port (port 104) to FR3 receive path 126 or FR3 transmit path 124 at a given time. Transmit/receive switch 184 may, for example, have a first switch state in which transmit/receive switch 184 couples port 104 to FR3 transmit path 126 and a second switch state in which transmit/receive switch 184 couples port 104 to FR3 receive path 124.

Transmit/receive switch 202 may selectively couple its third switch port (transmission line 176) to FR3 receive path 124 or FR3 transmit path 126 at a given time. Transmit/receive switch 204 may, for example, have a first switch state in which transmit/receive switch 204 couples transmission line 176 to FR3 transmit path 126 and a second switch state in which transmit/receive switch 204 couples transmission line 176 to FR3 receive path 124.

Transmission line 176, FR3 transmit path 126, FR3 receive path 124, and transmission line 96H-2 may convey horizontally polarized FR3 signals (denoted as FR3(H)) between the active horizontally polarized FR3 signal chain(s) in transceiver 44A (FIG. 8) and antenna 40B-2. Transmission line 176, FR3 transmit path 126, FR3 receive path 124, transmission line 96H-2, and the active horizontally polarized FR3 signal chain(s) in transceiver 44A may collectively form the radio-frequency transmission line path 46H (FIG. 4) for antenna 40B-2. FR3 transmit path 126 and FR3 receive path 124 may include respective transmission lines on and/or embedded within substrate 106.

FR2 circuitry 130 may communicatively couple IF path 116 to the positive antenna feed terminal 58V on antenna 40A-1 over transmission line 158, the positive antenna feed terminal 58V on antenna 40A-2 over transmission line 162, the positive antenna feed terminal 58V on antenna 40A-3 over transmission line 166, and the positive antenna feed terminal 58V on antenna 40A-4 over transmission line 170. FR2 circuitry 130 may communicatively couple IF path 118 to the positive antenna feed terminal 58H on antenna 40A-1 over transmission line 160, the positive antenna feed terminal 58H on antenna 40A-2 over transmission line 164, the positive antenna feed terminal 58H on antenna 40A-3 over transmission line 168, and the positive antenna feed terminal 58H on antenna 40A-4 over transmission line 172.

Transmission lines 154-176 may be implemented using any desired radio-frequency transmission line structures and may, if desired, be integrated into one or more flexible printed circuits coupled between RFFE module 106 and the phased antenna arrays. In other suitable implementations, RFFE module 108 (substrate 106) may be mounted to an underlying substrate (e.g., a package substrate, a rigid printed circuit board, a flexible printed circuit, etc.) and phased antenna arrays 50A and 50B (e.g., substrate 66 of FIGS. 5-7) may also be mounted to the underlying substrate. In these implementations, transmission lines 154-176 may be formed from conductive traces in the underlying substrate and extending from pins, terminals, or ports of RFFE module 108 to the positive antenna feed terminals of phased antenna arrays 50A and 50B.

RFFE module 108 is an integrated RFFE module that supports both FR2 and FR3 communications between transceiver 44A and phased antenna arrays 50A and 50B. If desired, RFFE module 108 and transceiver 44A (FIG. 8) may support concurrent operation in the FR2 band(s) and in the FR3 band(s) (e.g., RFFE module 108 and transceiver 44A may convey IF/FR2 signals using phased antenna array 50A concurrent with conveying FR3 signals using phased antenna array 50B). RFFE module 108 may be manufactured to include both components for supporting FR3 communications and components for supporting FR2 communications using the same semiconductor fabrication process (e.g., a CMOS process), minimizing cost, routing complexity, and process variations between FR2 and FR3 communications.

During FR3 signal transmission, FR2/FR3 selection switch 178 may receive vertically polarized FR3 signals over transmission line 96V-1, FR2/FR3 selection switch 180 may receive horizontally polarized FR3 signals over transmission line 96H-1, transmit/receive switch 182 may receive vertically polarized FR3 signals over transmission line 96V-2, and/or transmit/receive switch 184 may receive horizontally polarized FR3 signals over transmission line 96H-2.

If/when FR2/FR3 selection switch 178 receives vertically polarized FR3 signals over transmission line 96V-1, FR2/FR3 selection switch 178 may couple port 98 to FR3 transmit path 110 and transmit/receive switch 203 may couple FR3 transmit path 110 to transmission line 154. RFFE module 108 may transmit the vertically polarized FR3 signals from transmission line 96V-1, through FR2/FR3 selection switch 178, over FR3 transmit path 110, through transmit/receive switch 203, and over transmission line 154 to positive antenna feed terminal 58V on antenna 40B-1.

FR2/FR3 selection switch 178 and transmit/receive switch 203 may switch from transmitting FR3 signals to receiving FR3 signals by coupling FR3 receive path 107 between FR2/FR3 selection switch 178 and transmit/receive switch 203 instead of FR3 transmit path 110. Transmit/receive switch 203 may receive vertically polarized FR3 signals from antenna 40B-1 over transmission line 154 and may pass the vertically polarized FR3 signals onto FR3 receive path 107. FR2/FR3 selection switch 178 may pass the vertically polarized FR3 signals from FR3 receive path 107 to transceiver 44A (FIG. 8) over transmission line 96V-1.

If/when FR2/FR3 selection switch 180 receives horizontally polarized FR3 signals over transmission line 96H-1, FR2/FR3 selection switch 180 may couple port 100 to FR3 transmit path 114 and transmit/receive switch 205 may couple FR3 transmit path 114 to transmission line 156. RFFE module 108 may transmit the horizontally polarized FR3 signals from transmission line 96H-1, through FR2/FR3 selection switch 180, over FR3 transmit path 114, through transmit/receive switch 205, and over transmission line 156 to positive antenna feed terminal 58H on antenna 40B-1.

FR2/FR3 selection switch 180 and transmit/receive switch 205 may switch from transmitting FR3 signals to receiving FR3 signals by coupling FR3 receive path 112 between FR2/FR3 selection switch 180 and transmit/receive switch 205 instead of FR3 transmit path 114. Transmit/receive switch 205 may receive horizontally polarized FR3 signals from antenna 40B-1 over transmission line 156 and may pass the horizontally polarized FR3 signals onto FR3 receive path 112. FR2/FR3 selection switch 180 may pass the horizontally polarized FR3 signals from FR3 receive path 112 to transceiver 44A (FIG. 8) over transmission line 96H-1.

If/when transmit/receive switch 182 receives vertically polarized FR3 signals over transmission line 96V-2, transmit/receive switch 192 may couple port 102 to FR3 transmit path 122 and transmit/receive switch 202 may couple FR3 transmit path 122 to transmission line 174. RFFE module 108 may transmit the vertically polarized FR3 signals from transmission line 96V-2, through transmit/receive switch 182, over FR3 transmit path 122, through transmit/receive switch 202, and over transmission line 174 to positive antenna feed terminal 58V on antenna 40B-2.

Transmit/receive switch 182 and transmit/receive switch 202 may switch from transmitting FR3 signals to receiving FR3 signals by coupling FR3 receive path 120 between transmit/receive switch 182 and transmit/receive switch 202 instead of FR3 transmit path 122. Transmit/receive switch 202 may receive vertically polarized FR3 signals from antenna 40B-2 over transmission line 174 and may pass the vertically polarized FR3 signals onto FR3 receive path 120. Transmit/receive switch 182 may pass the vertically polarized FR3 signals from FR3 receive path 120 to transceiver 44A (FIG. 8) over transmission line 96V-2.

If/when transmit/receive switch 184 receives horizontally polarized FR3 signals over transmission line 96H-2, transmit/receive switch 184 may couple port 104 to FR3 transmit path 126 and transmit/receive switch 204 may couple FR3 transmit path 126 to transmission line 176. RFFE module 108 may transmit the FR3 signals from transmission line 96H-2, through transmit/receive switch 184, over FR3 transmit path 126, through transmit/receive switch 204, and over transmission line 176 to positive antenna feed terminal 58H on antenna 40B-2.

Transmit/receive switch 184 and transmit/receive switch 204 may switch from transmitting FR3 signals to receiving FR3 signals by coupling FR3 receive path 124 between transmit/receive switch 184 and transmit/receive switch 204 instead of FR3 transmit path 126. Transmit/receive switch 204 may receive horizontally polarized FR3 signals from antenna 40B-2 over transmission line 176 and may pass the horizontally polarized FR3 signals onto FR3 receive path 124. Transmit/receive switch 184 may pass the horizontally polarized FR3 signals from FR3 receive path 124 to transceiver 44A (FIG. 8) over transmission line 96H-2. If desired, the phase and magnitude controllers 52 (FIG. 3) for phased antenna array 50B may be integrated into RFFE module 108 rather than transceiver 44A. For example, the phase and magnitude controllers may be disposed on the portion of transmission lines 154, 156, 174, and 176 on substrate 106.

During FR2 signal transmission, FR2/FR3 selection switch 178 may receive vertically polarized IF signals over transmission line 96V-1 and/or FR2/FR3 selection switch 180 may receive horizontally polarized IF signals over transmission line 96H-1. If/when FR2/FR3 selection switch 178 receives vertically polarized IF signals over transmission line 96V-1 (denotated as IF(V)), FR2/FR3 selection switch 178 may couple port 98 to FR2 circuitry 130 over IF path 116. RFFE module 108 may transmit the vertically polarized IF signals from transmission line 96V-1, through FR2/FR3 selection switch 178, and over IF path 116 to FR circuitry 130.

One or more mixers 148 in FR2 circuitry 130 may upconvert the vertically polarized IF signals to produce vertically polarized FR2 signals. Amplifiers 146, filters 150, and/or switches 152 may also operate on the vertically polarized IF signals and/or the vertically polarized FR2 signals if desired. FR2 circuitry 130 may transmit the vertically polarized FR2 signals (denoted as FR2(V)) to the positive antenna feed terminal 58V on antenna 40A-1 over transmission line 158, to the positive antenna feed terminal 58V on antenna 40A-2 over transmission line 162, to the positive antenna feed terminal 58V on antenna 40A-3 over transmission line 166, and to the positive antenna feed terminal 58V on antenna 40A-4 over transmission line 170. Phase and magnitude controllers 52 in FR2 circuitry 130 may apply different phase and magnitude settings to the vertically polarized FR2 signals provided to antennas 40-1 through 40-4 (e.g., to configure phased antenna array 50A to form a signal beam of vertically polarized FR2 signals oriented in a corresponding beam pointing direction).

Conversely, during FR2 signal transmission, FR2 circuitry 130 may receive vertically polarized FR2 signals from antenna 40A-1 over transmission line 158, from antenna 40A-2 over transmission line 162, from antenna 40A-3 over transmission line 166, and antenna 40A-4 over transmission line 170. One or more mixers 148 in FR2 circuitry 130 may downconvert the vertically polarized FR2 signals to produce vertically polarized IF signals. Amplifiers 146, filters 150, and/or switches 152 may also operate on the vertically polarized IF signals and/or the vertically polarized FR2 signals if desired. Phase and magnitude controllers 52 in FR2 circuitry 130 may apply different phase and magnitude settings to the vertically polarized FR2 signals received from antennas 40-1 through 40-4 to cause the signals received from each of the antennas to coherently sum together. FR2 circuitry 130 may pass the vertically polarized IF signals to FR2/FR3 selection switch 178 over IF path 116. FR2/FR3 selection switch 178 may pass the vertically polarized IF signals to transceiver 44A (FIG. 8) over transmission line 96V-1.

If/when FR2/FR3 selection switch 180 receives horizontally polarized IF signals over transmission line 96H-1 (denotated as IF(H)), FR2/FR3 selection switch 180 may couple port 100 to FR2 circuitry 130 over IF path 118. RFFE module 108 may transmit the horizontally polarized IF signals from transmission line 96H-1, through FR2/FR3 selection switch 180, and over IF path 118 to FR circuitry 130.

One or more mixers 148 in FR2 circuitry 130 may upconvert the horizontally polarized IF signals to produce horizontally polarized FR2 signals. Amplifiers 146, filters 150, and/or switches 152 may also operate on the horizontally polarized IF signals and/or the horizontally polarized FR2 signals if desired. FR2 circuitry 130 may transmit the horizontally polarized FR2 signals (denoted as FR2(H)) to the positive antenna feed terminal 58H on antenna 40A-1 over transmission line 160, to the positive antenna feed terminal 58H on antenna 40A-2 over transmission line 164, to the positive antenna feed terminal 58H on antenna 40A-3 over transmission line 168, and to the positive antenna feed terminal 58H on antenna 40A-4 over transmission line 172. Phase and magnitude controllers 52 in FR2 circuitry 130 may apply different phase and magnitude settings to the horizontally polarized FR2 signals provided to antennas 40-1 through 40-4 (e.g., to configure phased antenna array 50A to form a signal beam of horizontally polarized FR2 signals oriented in a corresponding beam pointing direction).

Conversely, during FR2 signal transmission, FR2 circuitry 130 may receive horizontally polarized FR2 signals from antenna 40A-1 over transmission line 160, from antenna 40A-2 over transmission line 164, from antenna 40A-3 over transmission line 168, and antenna 40A-4 over transmission line 172. One or more mixers 148 in FR2 circuitry 130 may downconvert the horizontally polarized FR2 signals to produce horizontally polarized IF signals. Amplifiers 146, filters 150, and/or switches 152 may also operate on the horizontally polarized IF signals and/or the horizontally polarized FR2 signals if desired. Phase and magnitude controllers 52 in FR2 circuitry 130 may apply different phase and magnitude settings to the horizontally polarized FR2 signals received from antennas 40-1 through 40-4 to cause the signals received from each of the antennas to coherently sum together. FR2 circuitry 130 may pass the horizontally polarized IF signals to FR2/FR3 selection switch 180 over IF path 118. FR2/FR3 selection switch 180 may pass the vertically polarized IF signals to transceiver 44A (FIG. 8) over transmission line 96H-1.

RFFE module 108 may also include power management circuitry that is shared by both FR2 and FR3 communications. For example, RFFE module 108 may include a power management integrated circuit (PMIC) mounted to substrate 106 such as PMIC 132. PMIC 132 may receive DC power from a power supply or battery of device 10 that is external to RFFE module 108 (e.g., via one or more power ports, terminals, or pins of RFFE module 108). PMIC 132 may include one or more LDO regulators, DC-to-DC converters, and/or any other desired power delivery and/or management circuitry that convert power from external to RFFE module 108 into suitable voltages for powering the components of RFFE module 108.

PMIC 132 may, for example, power FR2 communications by transmitting power signals (e.g., power supply voltages, bias voltages, etc.) to one or more power input ports, pins, or terminals of FR2 circuitry 130 via power supply path 134. The power signals may power one or more of the components of FR2 circuitry 130 (e.g., amplifiers 146). PMIC 132 may also power FR3 communications by transmitting power signals to PAs 188, 192, 196, and 200 and LNAs 186, 190, 194, and 198 via power supply path 136.

In the example of FIGS. 8 and 9, transceiver 44A, RFFE module 108, and RF head 70 are described as performing FR2 communications in the FR2 band(s) and performing FR3 communications in the FR3 band(s). This is illustrative and non-limiting. In general, the FR2 band(s) may be replaced with any desired frequency bands at any desired frequencies and/or the FR3 band(s) may be replaced with any desired frequency bands at any desired frequencies.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. A radio-frequency front end (RFFE) module comprising:
a substrate;
a first switch on the substrate and having first, second, and third ports;
a second switch on the substrate and having fourth and fifth ports;
a transmit path on the substrate that couples the second port to the fourth port;
an integrated circuit (IC) mounted to the substrate; and
an intermediate frequency (IF) path on the substrate that couples the third port to the IC, wherein
the second switch is configured to communicatively couple the transmit path to a first phased antenna array via the fifth port,
the IC is configured to communicatively couple the IF path to a second phased antenna array,
the first switch is configured to route an IF signal between the first port and the IF path, and
the first switch is configured to route a radio-frequency (RF) signal from the first port onto the transmit path.

2. The RFFE module of claim 1, wherein the RF signal is in a first frequency band, the IC is configured to convert the IF signal between a second frequency band and a third frequency band, the second frequency band is lower than the first frequency band, and the third frequency band is higher than the first frequency band.

3. The RFFE module of claim 2, wherein the first frequency band comprises a Frequency Range 3 (FR3) band that includes a frequency greater than 7.125 GHz and less than 24.25 GHz and the second frequency band comprises a Frequency Range 2 (FR2) band that includes a frequency greater than 24.25 GHz and less than 75 GHz.

4. The RFFE module of claim 2, wherein the IC comprises phase and magnitude controllers configured to perform beam forming in the third frequency band for the second phased antenna array.

5. The RFFE module of claim 2, further comprising:
a third switch on the substrate and having sixth, seventh, and eighth ports;
a fourth switch on the substrate and having ninth and tenth ports;
an additional transmit path on the substrate that couples the eighth port to the ninth port; and
an additional IF path on the substrate that couples the seventh port to the IC.

6. The RFFE module of claim 5, wherein:
the fourth switch is configured to communicatively couple the additional transmit path to the first phased antenna array via the tenth port,
the IC is configured to communicatively couple the additional IF path to the second phased antenna array,
the third switch is configured to route an additional IF signal between the sixth port and the additional IF path, and
the third switch is configured to route an additional RF signal between the sixth port and the additional transmit path.

7. The RFFE module of claim 6, wherein:
the additional RF signal is in the first frequency band;
the additional IF signal is in the second frequency band;
the IC is configured to convert the additional IF signal between the second frequency band and the third frequency band;
the RF signal has a first polarization;
the IF signal has the first polarization;
the additional RF signal has a second polarization orthogonal to the first polarization; and
the additional IF signal has the second polarization.

8. The RFFE module of claim 2, further comprising:
a receive path on the substrate that couples a sixth switch port on the first switch to a seventh switch port on the second switch, wherein
the second switch is configured to communicatively couple the receive path to the first phased antenna array via the fifth port, and
the first switch is configured to route the RF signal from the receive path onto the first port.

9. The RFFE module of claim 8, further comprising:
a low noise amplifier disposed on the receive path;
a power amplifier disposed on the transmit path; and
a power management integrated circuit (PMIC) mounted to the substrate and configured to provide power to the low noise amplifier and the power amplifier over a first power supply path on the substrate.

10. The RFFE module of claim 9, wherein the PMIC is configured to provide power to the IC over a second power supply path on the substrate.

11. The RFFE module of claim 2, further comprising:
a third switch on the substrate and having sixth, seventh, and eighth ports;
a fourth switch on the substrate and having ninth and tenth ports;
a first additional transmit path on the substrate that couples the eighth port to the ninth port;
an additional IF path on the substrate that couples the seventh port to the IC, wherein
the second switch is configured to communicatively couple the transmit path to a first antenna feed terminal on a first antenna of the first phased antenna array,
the fourth switch is configured to communicatively couple the first additional transmit path to a second antenna feed terminal on the first antenna via the tenth port, and
the IC is configured to communicatively couple the IF path and the additional IF path to positive antenna feed terminals on second, third, fourth, and fifth antennas in the second phased antenna array;
fifth, sixth, seventh, and eighth switches on the substrate, the fifth switch having eleventh and twelfth ports, the sixth switch having thirteenth and fourteenth ports, the seventh switch having fifteenth and sixteenth ports, and the eighth switch having seventeenth and eighteenth ports;
a second additional transmit path coupled between the twelfth and thirteenth ports; and
a third additional transmit path coupled between the sixteenth and seventeenth ports, wherein
the third switch is configured to route an additional RF signal from the sixth terminal onto the first additional transmit path,
the fifth switch is configured to route the RF signal from the eleventh port onto the second additional transmit path,
the seventh switch is configured to route the additional RF signal from the thirteenth port onto the third additional transmit path,
the RF signal has a first polarization,
the additional RF signal has a second polarization orthogonal to the first polarization,
the sixth switch is configured to communicatively couple the second additional transmit path to a third antenna feed terminal on a second antenna of the first phased antenna array via the fourteenth port, and
the eighth switch is configured to communicatively couple the third additional transmit path to a fourth antenna feed terminal on the second antenna via the eighteenth port.

12. A transceiver chip comprising:
a first transmit chain that includes a first mixer configured to upconvert a first baseband signal to produce a first radio-frequency (RF) signal in a Frequency Range 3 (FR3) band;
a second transmit chain that includes a second mixer configured to upconvert a second baseband signal to produce a first intermediate frequency (IF) signal at an intermediate frequency lower than a Frequency Range 2 (FR2) band that is higher than the FR3 band, the second baseband signal including first wireless data to be transmitted in the FR2 band;
a first receive chain that includes a third mixer configured to downconvert a second RF signal from the FR3 band to produce a third baseband signal;
a second receive chain that includes a fourth mixer configured to downconvert a second IF signal at the intermediate frequency to produce a fourth baseband signal; and
a switch configured to communicatively couple one or more of the first transmit chain, the second transmit chain, the first receive chain, and the second receive chain to one or more ports of a RF front end (RFFE) module.

13. The transceiver chip of claim 12, further comprising:
a third transmit chain that includes a fifth mixer configured to upconvert a fifth baseband signal to produce a third RF signal in the FR3 band, wherein
the first and second RF signals are of a first polarization,
the third RF signal is of a second polarization orthogonal to the first polarization, and
the switch is configured to communicatively couple the third transmit chain to the one or more ports of the RFFE module.

14. The transceiver chip of claim 13, further comprising:
a fourth transmit chain that includes a sixth mixer configured to upconvert a sixth baseband signal to produce a third IF signal at the intermediate frequency, wherein
the sixth baseband signal includes second wireless data to be transmitted in the FR2 band,
the first and second IF signals are of the first polarization,
the third IF signal is of the second polarization, and
the switch is configured to communicatively couple the fourth transmit chain to the one or more ports of the RFFE module.

15. The transceiver chip of claim 14, further comprising:
a third receive chain that includes a seventh mixer configured to downconvert a fourth RF signal in the FR3 band to produce a seventh baseband signal, wherein
the fourth RF signal is of the second polarization, and
the switch is configured to communicatively couple the third receive chain to the one or more ports of the RFFE module.

16. The transceiver chip of claim 15, further comprising:
a fourth receive chain that includes an eighth mixer configured to downconvert a fourth IF signal at the intermediate frequency to produce an eighth baseband signal, wherein
the fourth IF signal is of the second polarization, and
the switch is configured to communicatively couple the fourth receive chain to the one or more ports of the RFFE module.

17. The transceiver chip of claim 16, wherein the first, second, third, and fourth IF signals are configured to be conveyed over a first phased antenna array external to the transceiver chip, the first, second, third, and fourth RF signals are configured to be conveyed over a second phased antenna array external to the transceiver chip, and the transceiver chip further comprises:
first, second, third, and fourth phase and magnitude controllers for the second phased antenna array, wherein
the first phase and magnitude controller is disposed on the first transmit chain between the first mixer and the switch,
the second phase and magnitude controller is disposed on the first receive chain between the third mixer and the switch,
the third phase and magnitude controller is disposed on the third transmit chain between the fifth mixer and the switch, and
the fourth phase and magnitude controller is disposed on the fourth transmit chain between the sixth mixer and the switch.

18. An electronic device comprising:
a first phased antenna array configured to convey first radio-frequency (RF) signals in a Frequency Range 3 (FR3) band;
a second phased antenna array configured to convey second RF signals in a Frequency Range 2 (FR2) band;
a transceiver chip, wherein the transceiver chip includes
first signal chains configured to convert the first RF signals between the FR3 band and baseband, and
second signal chains configured to convert intermediate frequency (IF) signals between baseband and a frequency lower than the FR2 band;
a radio-frequency front end (RFFE) module communicatively coupled between the transceiver chip and the first and second phased antenna arrays; and
an integrated circuit (IC) mounted to the RFFE module, the IC being configured to convert the second RF signals into the IF signals and being configured to convert the IF signals into the second RF signals.

19. The electronic device of claim 18, wherein the first phased antenna array comprises first, second, third, and fourth antennas separated by a first spacing, the second phased antenna array comprises fifth and sixth antennas separated by a second spacing larger than the first spacing, the second antenna overlaps the fifth antenna, and the fourth antenna overlaps the sixth antenna.

20. The electronic device of claim 18, wherein the first phased antenna array is configured to convey the first RF signals with first and second polarizations, the second polarization is orthogonal to the first polarization, the second phased antenna array is configured to convey the second RF signals with the first and second polarizations, the transceiver chip comprises first phase and magnitude controllers configured to perform beamforming for the first phased antenna array, and the IC comprises second phase and magnitude controllers configured to perform beamforming for the second phased antenna array.
